(19) United States
(12) Patent Application Publication
(10) Pub. No.: US 2007/0286059 A1
(43) Pub. Date: Dec. 13, 2007

(54) Optical Information Recording Medium and Optical Information Recording Method

(75) Inventors: Tetsuya Watanabe, Kanagawa (JP); Keita Takahashi, Kanagawa (JP); Kazutoshi Katayama, Kanagawa (JP)

Correspondence Address: SUGHRUE-265550, 2100 PENNSYLVANIA AVE. NW, WASHINGTON, DC, 20037-3213, US

(73) Assignee: FUJIFILM Corporation, Tokyo (JP)

(21) Appl. No.: 11/661,858

(22) PCT Filed: Dec. 27, 2005
(86) PCT No.: PCT/JP05/24255

§ 371 Date: Mar. 5, 2007

(30) Foreign Application Priority Data
Dec. 28, 2004 (JP) 2004-378973
Mar. 16, 2005 (JP) 2005-075552

(51) Int. Cl. G11B 7/24

(52) U.S. Cl. 369/275.3

(57) ABSTRACT

An optical information recording medium, comprising on a substrate a recording layer containing a dye compound having a specific structure. An optical information recording method, comprising recording information on the optical information recording medium by irradiation with laser light of a wavelength of 550 or shorter or 440 nm or shorter.

### TECHNICAL FIELD

The present invention relates to an optical information recording medium and an optical information recording method that enable recording-and-playback of information by use of laser light, and to novel compounds suitable for use in such a medium and a method. More specifically, the invention is concerned with a heat mode of optical information recording medium suitable for recording of information by use of laser light with short wavelengths of 550 nm or below (or 440 nm or below).

### BACKGROUND ART

Optical information recording media (optical discs) that enable one-time-only recording of information by means of laser light have so far been known. Such optical discs are referred to as write-once compact discs (the so-called CD-R). They have a typical structure that a recording layer containing an organic dye, a light reflection layer formed of a metal, such as gold, and a protective layer made from a resin are provided in order of mention in a multilayered state on a disk-form transparent substrate. The recording of information on a CD-R is performed by irradiation of a CD-R with laser light in the near infrared region (usually laser light with a wavelength of about 780 nm). More specifically, the recording layer absorbs the laser light in the irradiated areas and causes a local rise in temperature, and thereby the irradiated areas achieve a physical or chemical change (e.g., generation of pits) to change their optical characteristics; as a result, information is recorded on the CD-R. On the other hand, reading (playback) of information from the disc is generally performed by irradiating the disc with laser light of the same wavelength as the laser light used for recording has, and detecting difference in reflectivity between the area having changed in optical characteristics (recorded area) and the area remaining unchanged (unrecorded area) in the recording layer.

Recent years have seen the rapid proliferation of networks, such as the Internet, and high definition televisions (HDTV). With the broadcast on HDTV at hand, there has also been a growing need for large-capacity recording media enabling inexpensive-and-convenient recording of image information. The CD-R mentioned above and DVD-R (recordable digital versatile discs) capable of high-density recording by use of visible laser light (630 nm to 680 nm) as recording laser have established themselves as large-capacity recording media to a certain extent. However, it cannot be said that they have recording capacity large enough to address feature requirements. Therefore, development of optical discs which are improved in recording density by permitting the use of laser light with a shorter wavelength than DVD-R and have larger recording capacities than the DVD-R has been pursued. For instance, optical discs in the so-called Blu-ray format using blue laser with the wavelength of 405 nm are currently on the market.

The recording-and-playback methods in which information is recorded on and reproduced from optical information recording media having organic dye-containing recording layers by irradiating them with laser light of wavelengths not longer than 530 nm so that the laser light is directed toward the light reflection layer side from the recording layer side have been disclosed. More specifically, in the information recording-and-playback methods hitherto proposed, optical discs using as dyes in their respective recording layers porphyrin compounds, azo dyes, metal-azo dyes, quinophthalone dyes, trimethinecyanine dyes, dyes having dicyanovinylphenyl skeletons, coumarin compounds or naphthalocyanine compounds are irradiated with blue laser light (with wavelengths of 400 to 430 nm or a wavelength of 488 nm) or bluish-green laser light (with a wavelength of 515 nm), and thereby information is recorded and reproduced.

In addition, the information recording-and-playback method in which information is recorded on and reproduced from an optical disc using an oxonol dye as the dye in the recording layer by irradiation with a laser light of 550 nm or shorter has been proposed.

The background arts of dyes for those blue-laser recording discs include those disclosed in JP-A-11-053758 and JP-A-2001-71638

### DISCLOSURE OF THE INVENTION

However, our studies have found that the recording characteristics of optical discs using the dyes disclosed in those documents haven't been on a satisfactory level yet. Additionally, the optical discs using the oxonol dyes disclosed in JP-A-2001-71638 have found to be unsatisfactory in point of practicality because of the easiness with which the oxonol dyes are crystallized.

And we have discovered that the aforesaid problems can be solved by use of dyes having particular structures, thereby completing the invention.

An object of the invention is to provide an optical information recording medium on which high-density recording-and-playback of information can be made in good condition by irradiation with laser light of 550 nm or below, and besides, whose keeping quality is excellent.

Another object of the invention is to provide an information recording method that makes it possible to record and play back information under the aforesaid conditions.

The following are embodiments of the invention by which the aforesaid problems are well solved.

[1] An optical information recording medium, comprising on a substrate a recording layer containing a dye compound represented by either formula (I-1) or formula (I-2) or both; 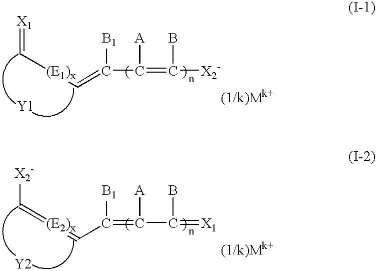
wherein moieties with the same symbols have the same meanings, respectively, and A, B and B₁ each independently represents a hydrogen atom or a univalent substituent, Y1 and Y2 each represents atoms forming a carbon ring or a hetero ring in conjunction with C-(E₁)ₓ-C or C=(E₂)ₓ=C, E₁ and E₂ each represents atoms completing a conjugated double bond chain, X₁ represents ═O, ═NR1 or ═C(R2)R3 wherein R1, R2 and R3 each independently represents a univalent substituent, X₂ represents —O, —NR1 or —C(R2)R3 wherein R1, R2 and R3 each independently represents a univalent substitutent, x represents 0 or 1, n represents 0, 1 or 2 wherein, when n is 2, two As are the same or different and two Bs are the same or different, M^{K+} represents a cation, and k represents an integer of 1 to 10. In the above formulae, it is preferable that at least either R2 or R3 in the moieties ═C(R2)R3 and —C(R2)R3 is —CN, —COR, —CO₂R, —SOR or —SO₂R, wherein R represents a univalent substituent, preferably an alkyl group or an aryl group.

[2] An optical information recording medium as described in [1], further comprising: a light reflection layer comprising metal; and/or a protective layer.

[3] An optical information recording medium as described in [1] or [2], wherein the substrate is a disk-form substrate (preferably, a disk-form transparent substrate) having in a surface part a pregroove with a track pitch of 0.2 to 0.5 μm and the recording layer is provided on the pregroove-formed surface of the substrate.

[4] An optical information recording method wherein information is recorded on an optical information recording medium as described in any of [1] to [3] by irradiation with laser light of a wavelength of 550 nm or shorter.

An object of the invention is to provide an optical information recording medium which enables high-density recording-and-playback of information in good condition by irradiation with laser light of 440 nm or below, and what is more, which has satisfactory keeping quality.

Another object of the invention is to provide an information recording method enabling recording-and-playback of information in the aforesaid conditions.

The following are embodiments of the invention by which the aforesaid objects are well achieved.

[5] An optical information recording medium, having a recording layer that contains a dye compound represented by formula (II-1); 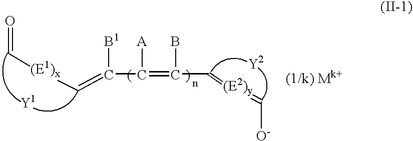
wherein A, B and B¹ each independently represents a hydrogen atom or a substituent; Y¹ and Y² each represents atoms forming a carbon ring or a hetero ring in conjunction with C-(E¹)ₓ-C or C=(E²)_{y}=C, respectively, E¹ and E² each represents atoms completing a conjugated double bond chain; x and y each represents 0 or 1; n represents 0, 1 or 2 wherein, when n is 2, two As are the same or different and two Bs are the same or different; M^{K+} represents a cation, and k represents an integer of 1 to 10. Herein, however, it is required that the carbon rings or the hetero rings formed by Y¹ and Y² being combined with C-(E¹)ₓ-C and C=(E²)_{y}=C, respectively, be different from each other

[6] An optical information recording medium as described in [5], further comprising: a light reflection layer comprising metal; and/or a protective layer.

[7] An optical information recording medium as described in [5] or [6], further comprising a substrate, wherein the substrate is a disk-form substrate (preferably, a disk-form transparent substrate) having in a surface part a pregroove with a track pitch of 0.2 to 0.5 μm and the recording layer containing the dye compound is provided on the pregroove-formed surface of the substrate.

[8] An information recording method, comprising recording information on an optical information recording medium as described in any of [5] to [7] by irradiation with laser light of a wavelength of 440 nm or shorter.

### BEST MODE FOR CARRYING OUT THE INVENTION

The optical information recording medium of the first embodiment of the present invention is characterized by incorporation of a dye compound (an oxonol dye) represented by either the following formula (I-1) or the following formula (I-2) or both in its recording layer.

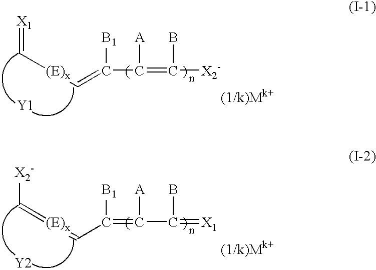

The optical information recording medium of the second embodiment of the present invention is characterized by incorporation of a dye compound (an oxonol dye) represented by the following formula (II-1) in its recording layer.

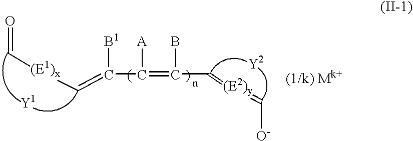

Dye compounds relating to the first and second embodiments of the invention are each formed of (B) a dye component exhibiting an anionic property (simply referred to as an anion part hereinafter) and (C) a component exhibiting a cationic property (simply referred to as a cation part hereinafter). Firstly, the anion part (B) is described in detail. In the above formulae, A, B, B₁ and B¹ are independent of one another and each of them represents a hydrogen atom or a univalent substituent. Examples of such a substituent include substituted or unsubstituted, linear, branched or cyclic alkyl groups containing 1 to 18 carbon atoms (preferably 1 to 8 carbon atoms), such as methyl, ethyl, propyl, isopropyl, n-butyl, isobutyl, sec-butyl, t-butyl, cyclohexyl, methoxyethyl, ethoxycarbonylethyl, cyanoethyl, diethylaminoethyl, hydroxyethyl, chloroethyl, acetoxyethyl, trifluoromethyl and aralkyl; alkenyl groups containing 2 to 18 carbon atoms (preferably 2 to 8 carbon atoms), such as vinyl; alkynyl groups containing 2 to 18 carbon atoms (preferably 2 to 8 carbon atoms), such as ethynyl; substituted or unsubstituted aryl groups containing 6 to 18 carbon atoms (preferably 6 to 10 carbon atoms), such as phenyl, 4-methylphenyl, 4-methoxyphenyl, 4-carboxyphenyl and 3,5-dicarboxyphenyl); substituted or unsubstituted aralkyl groups containing 7 to 18 carbon atoms (preferably 7 to 12 carbon atoms), such as benzyl and carboxybenzyl); substituted or unsubstituted acyl groups containing 2 to 18 carbon atoms (preferably 2 to 8 carbon atoms), such as acetyl, propionyl, butanoyl and chloroacetyl; substituted or unsubstituted alkyl- or arylsulfonyl groups containing 1 to 18 carbon atoms (preferably 1 to 8 carbon atoms), such as methanesulfonyl and p-toluenesulfonyl; alkylsulfinyl groups containing 1 to 18 carbon atoms (preferably 1 to 8 carbon atoms), such as methanesulfinyl, ethanesulfinyl and octanesulfinyl; alkoxycarbonyl groups containing 2 to 18 carbon atoms (preferably 2 to 8 carbon atoms), such as methoxycarbonyl, ethoxycarbonyl and butoxycarbonyl; aryloxycarbonyl groups containing 7 to 18 carbon atoms (preferably 7 to 12 carbon atoms), such as phenoxycaronyl, 4-methylphenoxycarbonyl and 4-methoxyphenylcarbonyl; substituted or unsubstituted alkoxy groups containing 1 to 18 carbon atoms (preferably 1 to 8 carbon atoms), such as methoxy, ethoxy, n-butoxy and methoxyethoxy; substituted or unsubstituted aryloxy groups containing 6 to 18 carbon atoms (preferably 6 to 10 carbon atoms), such as phenoxy and 4-methoxyphenoxy; alkylthio groups containing 1 to 18 carbon atoms (preferably 1 to 8 carbon atoms), such as methylthio and ethylthio; arylthio groups containing 6 to 10 carbon atoms (preferably 6 to 8 carbon atoms), such as phenylthio; substituted or unsubstituted acyloxy groups containing 2 to 18 carbon atoms (preferably 2 to 8 carbon atoms), such as acetoxy, ethylcarbonyloxy, cyclohexylcarbonyloxy, benzoyloxy and chloroacetyloxy; substituted or unsubstituted sulfonyloxy groups containing 1 to 18 carbon atoms (preferably 1 to 8 carbon atoms), such as methanesulfonyloxy; substituted or unsubstituted carbamoyloxy groups containing 2 to 18 carbon atoms (preferably 2 to 8-carbon atoms), such as methylcarbamoyloxy and diethylcarbamoyloxy; unsubstituted amino groups or substituted amino groups containing 1 to 18 carbon atoms (preferably 1 to 8 carbon atoms), such as methylamino, dimethylamino, diethylamino, anilino, methoxyphenylamino, chlorophenylamino, pyridylamino, methoxycarbonylamino, n-butoxycarbonylamino, phenoxycarbonylamino, phenylcarbamoylamino, ethylthiocarbamoylamino, methylsulfamoylamino, phenylsulfamoylamino, ethylcarbonylamino, ethylthiocarbonylamino, cyclohexylcarbonylamino, benzoylamino, chloroacetylamino, methanesulfonylamino and benzenesulfonylamino; amido groups containing 1 to 18 carbon atoms (preferably 1 to 8 carbon atoms), such as acetamido, acetylmethylamido and acetyloxtylamido; substituted or unsubstituted ureido groups containing 1 to 18 carbon atoms (preferably 1 to 8 carbon atoms), such as unsubstituted ureido, methylureido, ethylureido and dimethylureido; substituted or unsubstituted carbamoyl groups containing 1 to 18 carbon atoms (preferably 1 to 8 carbon atoms), such as unsubstituted carbamoyl, methylcarbamoyl, ethylcarbamoyl, n-butylcarbamoyl, t-butylcarbamoyl, dimethylcarbamoyl, morpholinocarbamoyl and pyrrolidinocarbamoyl; an unsubstituted sulfamoyl group and substituted sulfamoyl groups containing 1 to 18 carbon atoms (preferably 1 to 8 carbon atoms), such as methylsulfamoyl and phenylsulfamoyl; halogen atoms, such as fluorine, chlorine and bromine; a mercapto group; a nitro group; a cyano group; a carboxyl group; a sulfo group; a phosphono group, such as diethoxyphosphono; and heterocyclic groups, such as monovalent groups derived from oxazole, benzoxazole, thiazole, benzothiazole, imidazole, benzimidazole, indolene, pyridine, morpholine, piperidine, pyrrolidine, sulfolane, furan, thiophene, pyrazole, pyrrole, chroman and coumarin rings.

In the first embodiment, A is preferably a substituent, and it is advantageous to enhancement of dye's stability and color formability that the substituent has a Hammett's substituent constant (σp) of 0.2 or above. The Hammett's constants (σp) of substituents are listed, e.g., in Chem. Rev., 91, 165 (1991). The substituents preferred in particular are a cyano group, a nitro group, an alkoxy group, an alkoxycarbonyl group, an acyl group, a carbamoyl group, a sulfamoyl group, an alkylsulfonyl group and an arylsulfonyl group. B is preferably a substituent, and it is appropriate that the substituent be an alkyl group, an aryl group, an alkoxy group, an amino group or a substituted amino group. B₁ is preferably a halogen atom or a hydrogen atom, especially a hydrogen atom.

In the second embodiment, each of A, B and B¹ is preferably an alkyl group, a halogen atom or a hydrogen atom, particularly preferably a hydrogen atom.

In the first embodiment, since [—C(═CR)-(E)ₓ-C(═X₁)—] (hereinafter represented by W₁ for convenience) binding to Y₁ and [—C(—CR)=(E)ₓ=C(—X₂⁻)—] (hereinafter represented by W₂ for convenience) binding to Y₂ are each in a conjugate state, the carbon or hetero ring formed of W₁ and Y₁ and the carbon or hetero ring formed Of W₂ and Y₂ are each regarded as one of resonance structures. In the second embodiment, the moiety [—C(═C)-(E¹)ₓ-C(═O)—] (hereinafter represented by W₁ for convenience) binding to Y¹ and the moiety [—C(—C)=(E²)_{y}═C(—O⁻)—] (hereinafter represented by W² for convenience) binding to Y² are each in a conjugate state, so the carbon or hetero ring formed of W¹ and Y¹ and the carbon or hetero ring formed of W² and Y² are each regarded as one of resonance structures.

The carbon or hetero ring formed of Y₁ and W₁ and the carbon or hetero ring formed of Y₂ and W₂, and the carbon or hetero ring formed of Y¹ and W¹ and the carbon or hetero ring formed of Y² and W² each are preferably 4- to 7-membered rings, particularly preferably 5- or 6-membered rings. These rings each may be fused with another 4- to 7-membered ring to form a fused ring. In addition, these rings each may have a substituent. Examples of such a substituent include those recited above as the substituents represented by A, B, B₁ and R. Suitable examples of a hetero atom forming the hetero ring include B, N, O, S, Se and Te. Of these atoms, N, O and S are preferred over the others. x and y each is 0 or 1, preferably 0.

X₁ represents ═O, ═NR1 or ═C(R2)R3. X₂ represents —O, —NR1 or —C(R2)R3. R1, R2 and R3 are independent of one another, and they each represent a univalent substituent. Examples of substituents represented by R1 to R3 include those recited above as the substituents represented by A, B and B₁. It is preferable that R1, R2 and R3 are each an alkyl group (such as methyl and ethyl), an aryl group (such as phenyl), a cyano group, an alkoxycarbonyl group (such as methoxycarbonyl and butoxycarbonyl) an alkylsulfonyl group (such as methanesulfonyl) or an arylsulfonyl group (such as benzenesulfonyl). In the invention, the case where X₁ is ═O and X₂ is —O is preferred.

Examples of a carbon or hetero ring formed of Y₁ and W₁ and the carbon or hetero ring formed of Y₂ and W₂, and the carbon or hetero ring formed of Y¹ and W¹ and the carbon or hetero ring formed of Y² and W² each are illustrated below. Additionally, Ra, Rb and Rc in the following formulae are independent of one another, and each of them represents a hydrogen atom or a substituent.

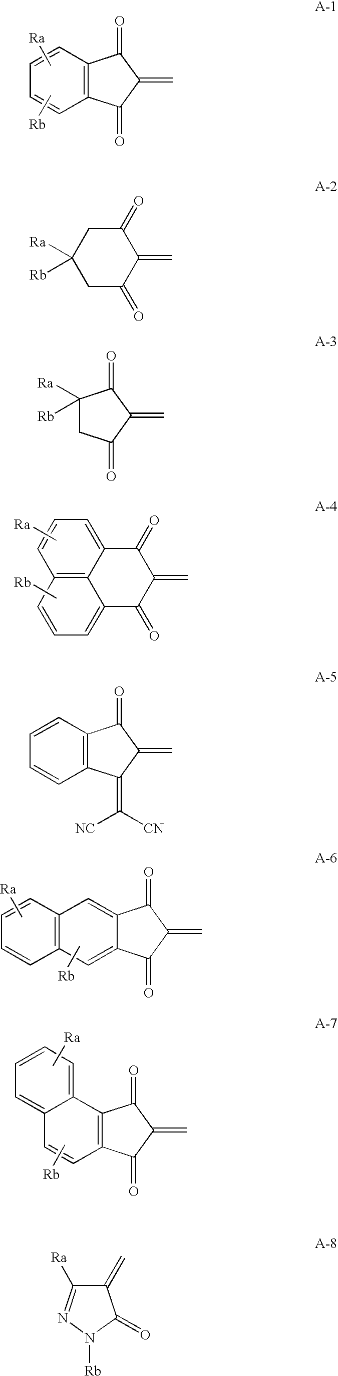

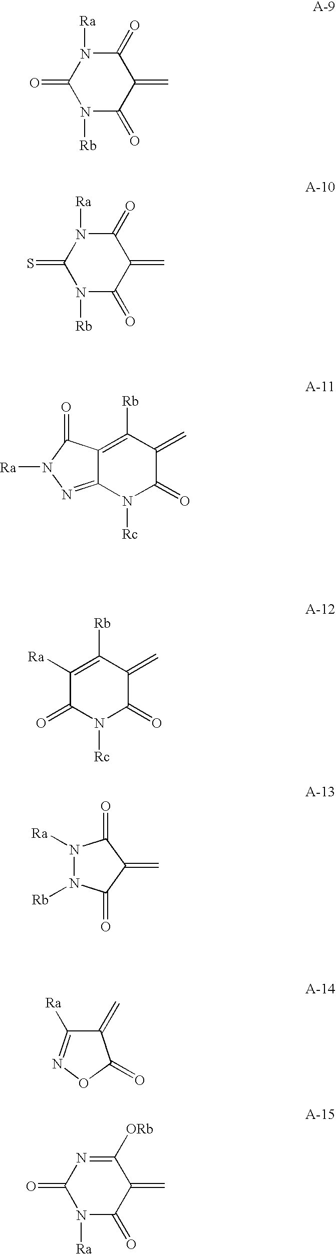

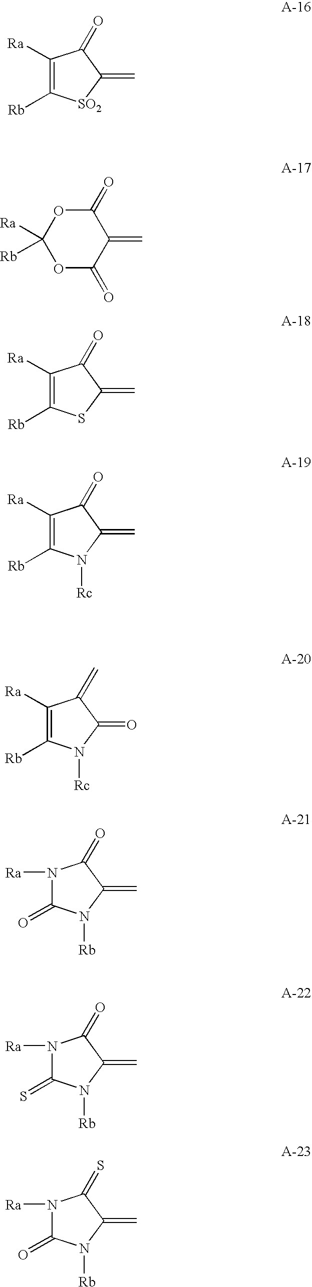

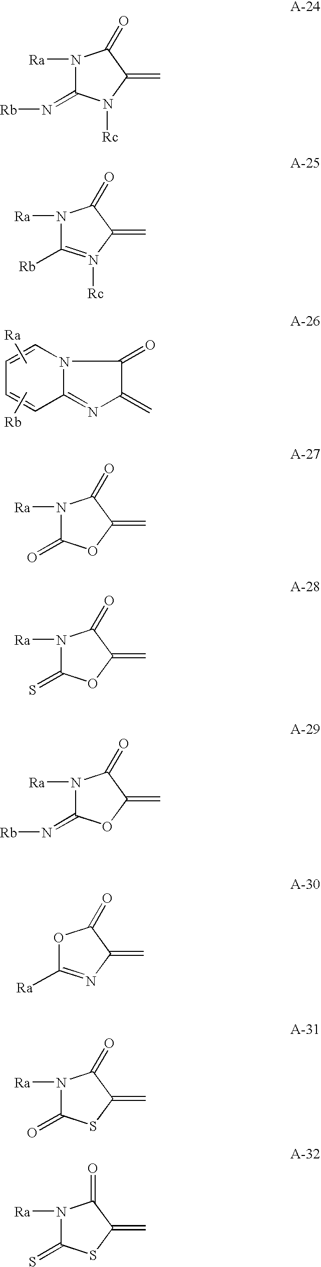

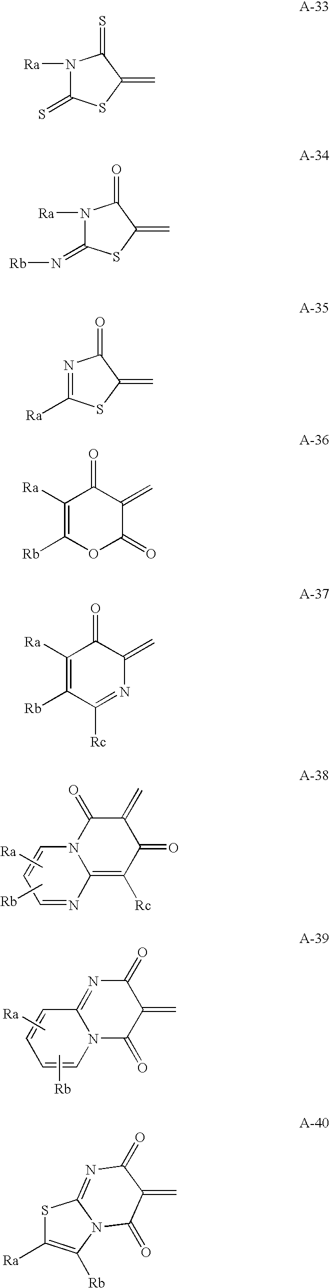

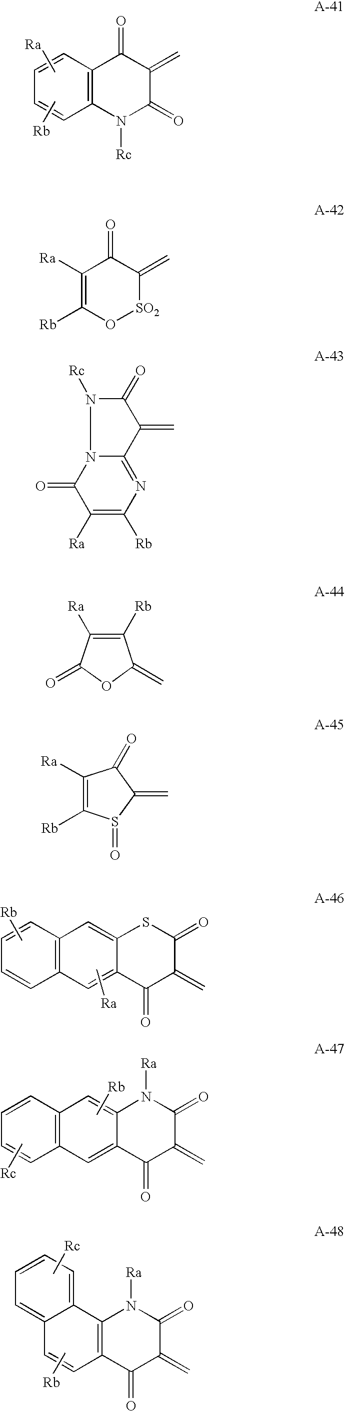

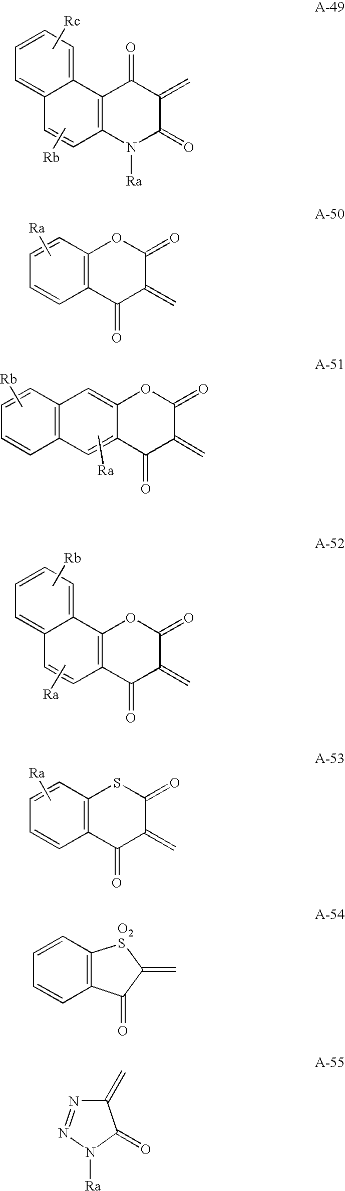

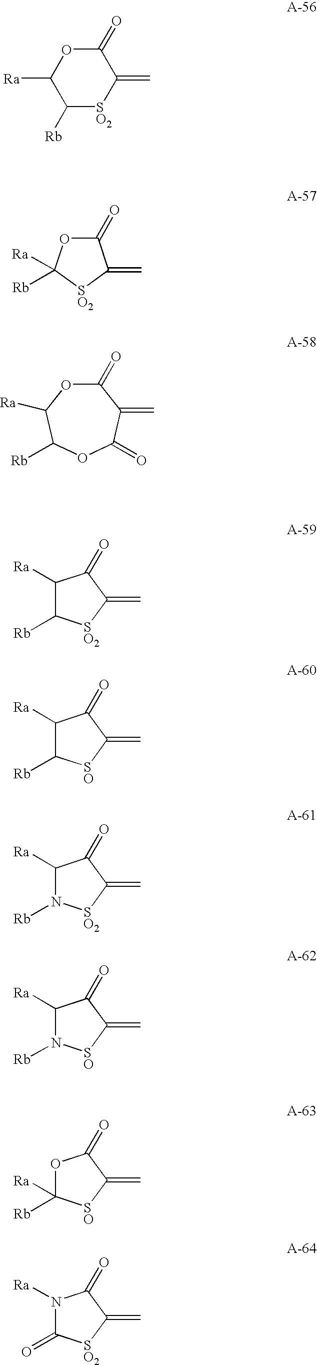

Of the rings recited above, the carbon rings or the hetero rings denoted by A-8, A-9, A-10, A-11, A-12, A-13, A-14, A-16, A-17, A-36, A-39, A-41, A-54 and A-57 are preferred over the others. And the rings denoted by A-8, A-9, A-10, A-13, A-14, A-16, A-17 and A-57 are preferable by far. Above all, those denoted by A-9, A-10, A-13, A-17 and A-57 are best suited.

It is advantageous to make a combination of carbon rings, or hetero rings, or carbon and hetero rings situated at both ends of an oxonol dye according to the invention so that the oxonol dye has its absorption maximum in the wavelength region of 350 nm to 390 nm. More specifically, it is preferable that one of the carbon rings, or the hetero rings or the carbon and hetero rings situated at both ends of the oxonol dye is a ring chosen from A-8, A-9, A-10, A-11, A-12, A-13, A-14, A-16, A-17, A-36, A-39, A-41, A-54 or A-57 and the other is a ring different from the chosen one, and that, one which is chosen from A-8, A-9, A-10, A-11, A-12, A-13, A-14, A-16, A-17, A-36, A-39, A-41, A-54 or A-57.

The substituent represented by Ra, Rb and Rc each include those recited above as the substituent represented by A, B, B₁ and B¹ each. Alternatively, any two of Ra, Rb and Rc may combine with each other to form a carbon or hetero ring. Examples of such a carbon ring include 4- to 7-membered carbon rings, such as a cyclohexane ring, a cyclopentane ring, a cyclohexene ring and a benzene ring, and examples of such a hetero ring include saturated and unsaturated 4- to 7-membered hetero rings, such as a piperidine ring, a piperazine ring, a morpholine ring, a tetrahydrofuran ring, a furan ring, a thiophene ring, a pyridine ring and a pyrazine ring. These carbon rings and hetero rings may further be substituted. Examples of groups with which those rings may further be substituted include those recited above as the substituent represented by A, B and B₁ each.

In formulae (I-1) and (1-2), n represents 0, 1 or 2, preferably 0 or 1. When n is 2, two As may be the same or different and two Bs also may be the same or different.

In formula (I-1), it is preferable that n is 1, X₁ is ═O and X₂ is O. In formula (I-2), it is preferable that n is 0, X₁ is ═C(R2)R3 and X₂ is O.

In the formula (II-1) of the invention, the carbon or hetero ring formed of Y¹ and W¹ is different from the carbon or hetero ring formed of Y² and W². The expression “the carbon or hetero ring formed of Y¹ and W¹ is different from the carbon or hetero ring formed of Y² and W²” does not signify a representation difference in resonance structures and differences in substituents, such as Ra, Rb and Rc in the above-recited structures A-1 to A-64, but signifies a difference in pKa values of hydrogen atoms in a case where every carbon ring and every hetero ring are illustrated in a neutral state and the hydrogen atoms are virtually attached to the carbon atoms linked with the methine-chain part (═C(B¹)-(C(A)=C(B))ₙ— in formula (II-1)). More specifically, the foregoing expression means that there is a difference in pKa between the sites marked with asterisks in the following formulae (A) and (B).

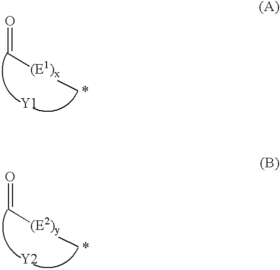

For instance, two different rings selected from among the above-recited structures A-1 to A-64 can be said that one of the two is different from the other.

n represents 0, 1 or 2, preferably 0 or 1. When n is 2, two As may be the same or different and two Bs may be the same or different.

Next the cation part in the first embodiment is described in detail. Examples of a cation represented by M^{k+} include a hydrogen ion, metal ions, such as ions of sodium, potassium, lithium, calcium, iron and copper, metal complex ions, ammonium ions, pyridinium ions, oxonium ions, sulfonium ions, phosphonium ions, selenonium ions and iodonium ions. Of these ions, quaternary ammonium ions are preferred over the others.

Quaternary ammonium ions are generally produced by alkylation (Menshutkin reaction), alkenylation, alkynylation or arylation of tertiary amines (e.g., trimethylamine, triethylamine, tributylamine, triethanolamine, N-methylpyrrolidine, N-methylpiperidine, N,N-dimethylpiperazine, triethylenediamine, N,N,N′,N′-tetramethylethylenediamine) or nitrogen-containing hetero rings (e.g., a pyridine ring, a picoline ring, a 2,2′-bipyridyl ring, a 4,4′-bipyridyl ring, a 1,10-phenanthroline ring, a quinolin-e ring, an oxazole ring, a thiazole ring, an N-methylimidazole ring, a pyrazine ring, a tetrazole ring).

As the quaternary ammonium ion represented by M^{k+}, quaternary ammonium ions including nitrogen-containing hetero rings are preferred, and quaternary pyridinium ions are especially preferred.

k represents an integer of 1 to 10, preferably 1 to 4, particularly preferably 1 or 2.

As the cation represented by M^{k+}, cations represented by the following formula (I-3) are furthermore preferred. These compounds can be easily produced by the Menshutkin reaction between 2,2′-bipyridyl or 4,4′-bipyridyl and halides having the desired substituents (See, e.g., JP-A-61-148162) or by arylation reaction according to the method described in JP-A-51-16675 or JP-A-1-96171.

Formula (I-3)

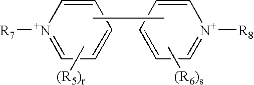

In the above formula, R₅ and R₆ are independent of each other, and each of them represents a substituent. R₇ and R₈ are also independent of each other, and each of them represents an alkyl group, an alkenyl group, an alkynyl group, an aralkyl group, an aryl group or a heterocyclic group. Alternatively, R₅ and R₆, or R₅ and R₇, or R₆ and R₈, or R₇ and R₈ may combine with each other to form a ring. r and s are independent of each other, and each of them represents an integer of 0 to 4. When r and s are each an integer of 2 or above, a plurality of R₅ₛ may be the same or different and a plurality of R₆ₛ may be the same or different.

The alkyl group represented by R₇ and R₈ each is preferably a substituted or unsubstituted alkyl group containing 1 to 18 carbon atoms, far preferably a substituted or unsubstituted alkyl group containing 1 to 8 carbon atoms. Such an alkyl group may have any of straight-chain, branched-chain and cyclic forms. Examples thereof include methyl, ethyl, n-propyl, isopropyl, n-butyl, isobutyl, t-butyl, n-hexyl, neopentyl, cyclohexyl, adamantyl and cyclopropyl groups.

The following are included in examples of substituents those alkyl groups may have: Substituted or unsubstituted alkenyl groups containing 2 to 18 carbon atoms (preferably 2 to 8 carbon atoms) such as a vinyl group; substituted or unsubstituted alkynyl groups containing 2 to 18 carbon atoms (preferably 2 to 8 carbon atoms, such as an ethynyl group; substituted or unsubstituted aryl groups containing 6 to 10 carbon atoms, such as a phenyl group and a naphthyl group; halogen atoms, such as F, Cl and Br; substituted or unsubstituted alkoxy groups containing 1 to 18 carbon atoms (preferably 1 to 8 carbon atoms), such as a methoxy group and an ethoxy group; substituted or unsubstituted aryloxy groups containing 6 to 10 carbon atoms, such as an phenoxy group and a p-methoxyphenoxy group; substituted or unsubstituted alkylthio groups containing 1 to 18 carbon atoms (preferably 1 to 8 carbon atoms), such as a methylthio group and an ethylthio group; substituted or unsubstituted arylthio groups containing 6 to 10 carbon atoms, such as a phenylthio group; substituted or unsubstituted acyl group containing 2 to 18 carbon atoms (preferably 2 to 8 carbon atoms), such as an acetyl group and a propionyl group; substituted or unsubstituted alkylsulfonyl or arylsulfonyl groups containing 1 to 18 carbon atoms (preferably 1 to 8 carbon atoms), such as a methanesulfonyl group or a p-toluenesulfonyl group; substituted or unsubstituted acyloxy groups containing 2 to 18 carbon atoms (preferably 2 to 8 carbon atoms), such as an acetoxy group and a propionyloxy group; substituted or unsubstituted alkoxycarbonyl groups containing 2 to 18 carbon atoms (preferably 2 to 8 carbon atoms), such as a methoxycarbonyl group and an ethoxycarbonyl group; substituted or unsubstituted aryloxycarbonyl groups containing 7 to 11 carbon atoms, such as a naphthoxycarbonyl group; an unsubstituted amino group or substituted amino groups containing 1 to 18 carbon atoms (preferably 1 to 8 carbon atoms), such as a methylamino group, a dimethylamino group, a diethylamino group, an anilino group, a methoxyphenylamino group, a chlorphenylamino group, a pyridylamino group, a methoxycarbonylamino group, a n-butoxycarbonylamino group, a phenoxycarbonylamino group, a methylcarbamoylamino group, an ethylthiocarbamoylamino group, a phenylcarbamoylamino group, an acetylamino group, an ethylcarbonylamino group, an ethylthiocarbamoylamino group, a cyclohexylcarbonylamino group, a benzoylamino group, a chloroacetylamino group and a methylsulfonylamino group; substituted or unsubstituted carbamoyl groups containing 1 to 18 carbon atoms (preferably 1 to 8 carbon atoms), such as an unsubstituted carbamoyl group, a methylcarbamoyl group, an ethylcarbamoyl group, an n-butylcarbamoyl group, a t-butylcarbamoyl group, a dimethylcarbamoyl group, a morpholinocarbamoyl group and pyrrolidinocarbamoyl group; an unsubstituted sulfamoyl group, or substituted sulfamoyl groups containing 1 to 18 carbon atoms (preferably 1 to 8 carbon atoms), such as a methylsulfamoyl group and a phenylsulfamoyl group; a cyano group; a nitro group; a carboxyl group; a hydroxyl group; and heterocyclic groups, such as univalent groups derived from oxazole, benzoxazole, thiazole, benzothiazole, imidazole, benzimidazole, indolenine, pyridine, piperidine, pyrrolidine, morpholine, sulfolane, furan, thiophene, pyrazole, pyrrole, chroman and coumarin rings.

The alkenyl group represented by R₇ and R₈ each is preferably a substituted or unsubstituted alkenyl group containing 2 to 18 carbon atoms, far preferably a substituted or unsubstituted alkenyl group containing 2 to 8 carbon atoms, with examples including a vinyl group, an allyl group, a 1-propenyl group and a 1,3-butadienyl group. Suitable examples of a substituent the alkenyl group can have are those recited above as substituents the alkyl group may have.

The alkynyl group represented by R₇ and R₈ each is preferably a substituted or unsubstituted alkynyl group containing 2 to 18 carbon atoms, far preferably a substituted or unsubstituted alkynyl group containing 2 to 8 carbon atoms, with examples including an ethynyl group and a 2-propynyl group. Suitable examples of a substituent the alkynyl group can have are those recited above as substituents the alkyl group may have.

The aralkyl group represented by R₇ and R₈ each is preferably a substituted or unsubstituted aralkyl group containing 7 to 18 carbon atoms, with examples including a benzyl group and a methylbenzyl group. Examples of a substituent the aralkyl group can have are those recited above as substituents the alkyl group may have.

The aryl group represented by R₇ and R₈ each is preferably a substituted or unsubstituted aryl group containing 6 to 18 carbon atoms, with examples including a phenyl group and a naphthyl group. Suitable examples of a substituent the aryl group can have are those recited above as substituents the alkyl group may have. In addition, alkyl groups (e.g., methyl, ethyl) are also suitable as the substituents the aryl group can have.

The heterocyclic group represented by R₇ and R₈ each is a univalent group derived from a saturated or unsaturated 5- or 6-membered hetero ring made up of carbon atoms and nitrogen, oxygen or/and sulfur atoms. Examples of such a hetero ring include an oxazole ring, a benzoxazole ring, a thiazole ring, a benzothiazole ring, an imidazole ring, a benzimidazole ring, an indolenine ring, a pyridine ring, a piperidine ring, a pyrrolidine ring, a morpholine ring, a sulfolane ring, a furan ring, a thiophene ring, a pyrazole ring, a pyrrole ring, a chroman ring and a coumarin ring. These heterocyclic rings may have substituents. Suitable examples of such substituents are those recited above as substituents the alkyl group may have.

The substituent represented by R₅ and R₆ each includes those recited above as substituents the alkyl group may have. In addition thereto, alkyl groups (e.g., methyl, ethyl) can be included therein.

r and s are independent of each other, and they each represent an integer of 0 to 4, preferably 0 or 1, particularly preferably 0.

Examples of the anion part (denoted by [B-]) and the cation part (denoted by [C-]) of a dye compound represented by formula (I-1) or/and formula (I-2) according to the invention are illustrated in the following lists. However, these examples should not be construed as limiting the scope of the invention. Additionally, some of the anion parts of dye compounds recited below as examples according to the invention can be expressed in both of formulae (I-1) and (1-2), but their expressions are unified into formula (I-2) in the following lists for convenience sake. For instance, B-1 in the list, though it can be expressed in both B-1b belonging to formula (I-1) and B-1a belonging to formula (I-2) as shown below, is expressed in B-1a as the representative of these formulae.

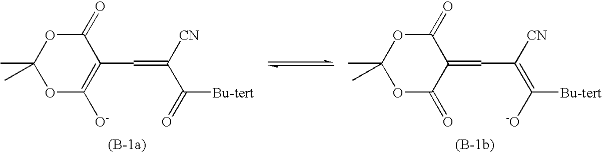

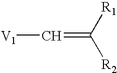

| No. | V₁ | R₁ | R₂ |
|---|---|---|---|
| B-1 | 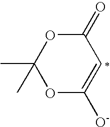 | CN | COBu-tert |
| B-2 | 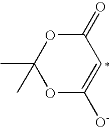 | CN | CO₂CH₃ |
| B-3 | 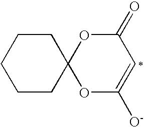 | CN | SO₂Ph |
| B-4 | 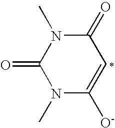 | CN | CO₂CH₃ |
| B-5 | 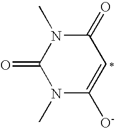 | SO₂CH₃ | CO₂CH₃ |
| B-6 | 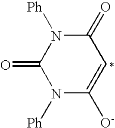 | CN | CO₂CH₃ |
| B-7 | 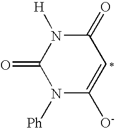 | SO₂CH₃ | CO₂CH₃ |
| B-8 | 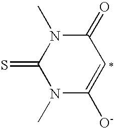 | CN | SO₂Ph |
| B-9 | 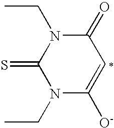 | CN | SO₂CH₃ |
| B-10 | 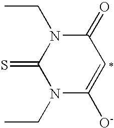 | CO₂C₂H₅ | SO₂CH₃ |
| B-11 | 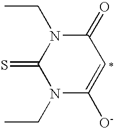 | CO₂C₂H₅ | SO₂CH₃ |

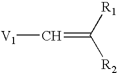

| No. | V₁ | R₁ | R₂ |
|---|---|---|---|
| B-12 | 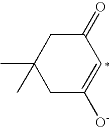 | CN | CO₂CH₃ |
| B-13 | 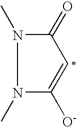 | CN | COCH₃ |
| B-14 | 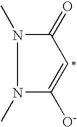 | CN | SO₂Ph |
| B-15 | 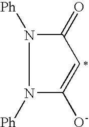 | CN | CO₂CH₃ |
| B-16 | 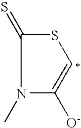 | SO₂CH₃ | CO₂CH₃ |
| B-17 | 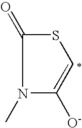 | CN | CO₂CH₃ |
| B-18 | 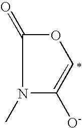 | CN | COCH₂CH₃ |
| B-19 | 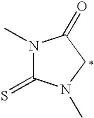 | CN | SO₂Ph |
| B-20 | 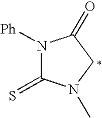 | CN | CO₂CH₃ |
| B-21 | 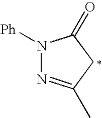 | CN | SO₂Ph |
| B-22 | 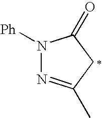 | CO₂C₂H₅ | SO₂CH₃ |

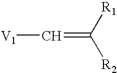

| No. | V₁ | R₁ | R₂ |
|---|---|---|---|
| B-23 | 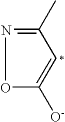 | CN | COCH₃ |
| B-24 | 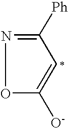 | CN | CO₂CH₃ |
| B-25 | 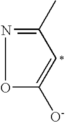 | CN | SO₂Ph |
| B-26 | 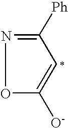 | CN | CN |
| B-27 | 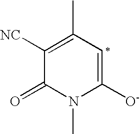 | SO₂CH₃ | CO₂CH₃ |
| B-28 | 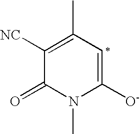 | CN | CO₂CH₃ |
| B-29 | 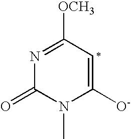 | CN | COCH₂CH₃ |
| B-30 | 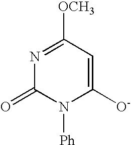 | CN | SO₂Ph |

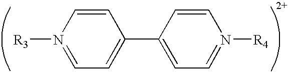

| No. | R₃ | R₄ |
|---|---|---|
| C-1 | 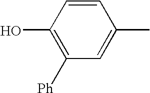 | 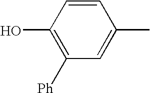 |
| C-2 | 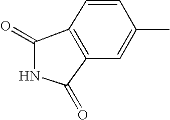 | 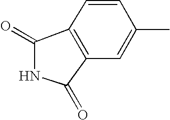 |
| C-3 | 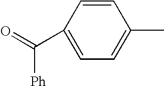 | 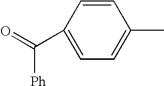 |
| C-4 | 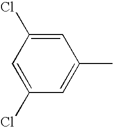 | 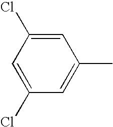 |
| C-5 | 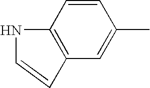 | 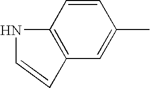 |
| C-6 | 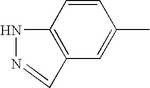 | 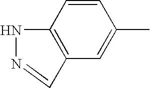 |
| C-7 | 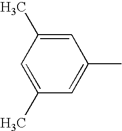 | 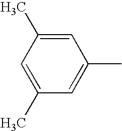 |
| C-8 | 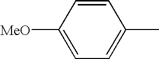 | 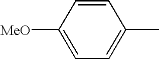 |
| C-9 | 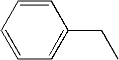 | 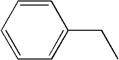 |
| C-10 | C₂H₅ | C₂H₅ |

| | | | | |
|---|---|---|---|---|
| C-11 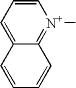 | C-12 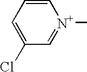 | C-13 N(Bu)₄⁺ | C-14 Na⁺ | C-15 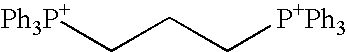 |

Examples of a compound suitably used in the first embodiment of the invention are shown in Table 1. Each compound (Dye) example shown in Table 1 is a combination of its corresponding anion part and cation part.

TABLE 1

| Compound No. | Anion part | Cation part |
|---|---|---|
| S-1 | B-1 | C-1 |
| S-2 | B-1 | C-2 |
| S-3 | B-1 | C-11 |
| S-4 | B-4 | C-1 |
| S-5 | B-4 | C-2 |
| S-6 | B-9 | C-1 |
| S-7 | B-9 | C-2 |
| S-8 | B-9 | C-3 |
| S-9 | B-11 | C-3 |
| S-10 | B-13 | C-4 |
| S-11 | B-13 | C-5 |
| S-12 | B-15 | C-7 |
| S-13 | B-16 | C-8 |
| S-14 | B-20 | C-10 |
| S-15 | B-22 | C-9 |

The dye compounds relating to the invention and represented by formula (I-1) or formula (I-2) or both may be used alone or as a mixture of two or more thereof. Alternatively, the dye compounds relating to the invention may be used in combination with other dye compounds.

Examples of the anion part (denoted by [B-]) and the cation part (denoted by [C-]) of a dye compound represented by formula (II-1) according to the invention are illustrated in the following lists. However, these examples should not be construed as limiting the scope of the invention.

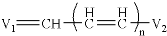

| No. | V₁ | V₂ | n |
|---|---|---|---|
| B-1′ | 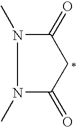 | 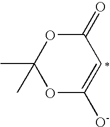 | 0 |
| B-2′ | 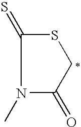 | 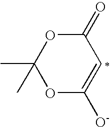 | 0 |
| B-3′ | 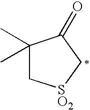 | 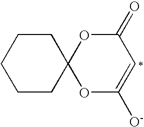 | 0 |
| B-4′ | 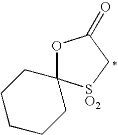 | 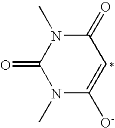 | 0 |
| B-5′ | 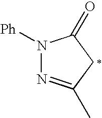 | 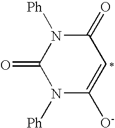 | 0 |
| B-6′ | 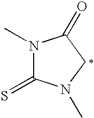 | 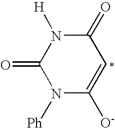 | 0 |
| B-7′ | 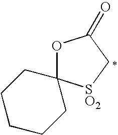 | 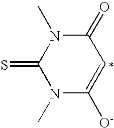 | 1 |
| B-8′ | 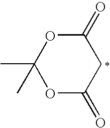 | 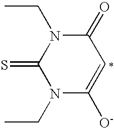 | 1 |
| B-9′ | 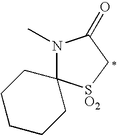 | 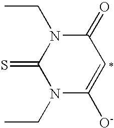 | 1 |
| B-10′ | 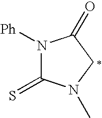 | 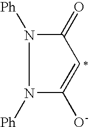 | 2 |

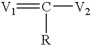

| No. | V₁ | V₂ | R |
|---|---|---|---|
| B-11′ | 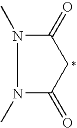 | 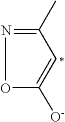 | Cl |
| B-12′ | 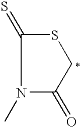 | 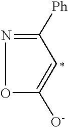 | Me |
| B-13′ | 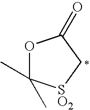 | 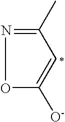 | Cl |
| B-14′ | 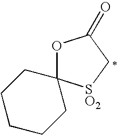 | 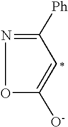 | Me |
| B-15′ | 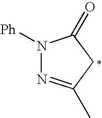 | 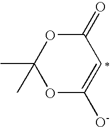 | Ph |

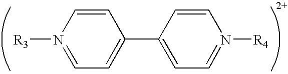

| No. | R₃ | R₄ |
|---|---|---|
| C-1′ | 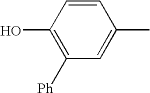 | 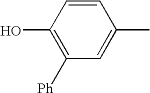 |
| C-2′ | 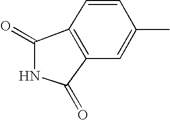 | 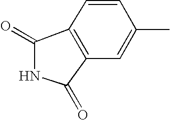 |
| C-3′ | 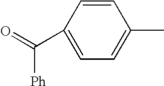 | 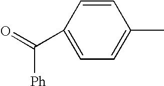 |
| C-4′ | 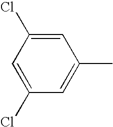 | 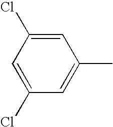 |
| C-5′ | 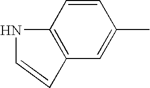 | 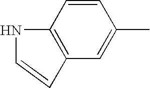 |
| C-6′ | 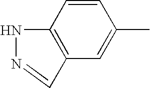 | 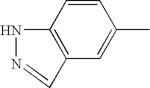 |
| C-7′ | 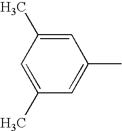 | 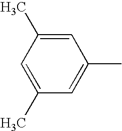 |
| C-8′ | 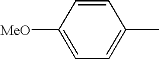 | 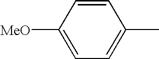 |
| C-9′ | 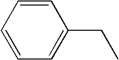 | 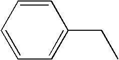 |
| C-10′ | C₂H₅ | C₂H₅ |

| | | | | |
|---|---|---|---|---|
| C-11′ 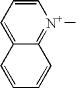 | C-12′ 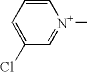 | C-13′N(Bu)₄⁺ | C-14′Na⁺ | C-15′ 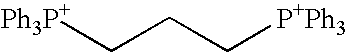 |

Suitable examples of a compound for use in the invention are shown in Table 1. Each compound example (S—) shown in Table 1 is a combination of its corresponding anion part and cation part.

TABLE 2

| Compound No. | Anion part | Cation part |
|---|---|---|
| S-1′ | B-1′ | C-1′ |
| S-2′ | B-1′ | C-2′ |
| S-3′ | B-1′ | C-11′ |
| S-4′ | B-4′ | C-1′ |
| S-5′ | B-4′ | C-2′ |
| S-6′ | B-4′ | C-3′ |
| S-7′ | B-6′ | C-1′ |
| S-8′ | B-9′ | C-3′ |
| S-9′ | B-11′ | C-3′ |
| S-10′ | B-14′ | C-4′ |

The dye compounds represented by formula (II-1) relating to the invention may be used alone or as a mixture of two or more thereof. Alternatively, the dye compounds relating to the invention may be used in combination with other dye compounds.

In a recording layer of the present information recording medium, various discoloration inhibitors can be incorporated for the purpose of enhancing light resistance of the recording layer. Compounds usable as the discoloration inhibitors include organic oxidants and singlet-state oxygen quenchers. As the organic oxidants used as discoloration inhibitors, the compounds disclosed in JP-A-10-151861 are suitable. As the singlet-state oxygen quenchers, those already known in publications including patent specifications can be utilized. Examples thereof include the singlet-state oxygen quenchers disclosed in JP-A-58-175693, JP-A-59-81194, JP-A-60-18387, JP-A-60-19586, JP-A-60-19587, JP-A-60-35054, JP-A-60-36190, JP-A-60-36191, JP-A-60-44554, JP-A-60-44555, JP-A-60-44389, JP-A-60-44390, JP-A-60-54892, JP-A-60-47069, JP-A-63-209995, JP-A-4-25492, JP-B-1-38680, JP-B-6-26028, German Patent No. 350399, and Nippon Kagakukai-Shi, page 1141, the Oct. issue (1992). More specifically, singlet-state oxygen quenchers represented by the following formula (II) are used to advantage:

Formula (II)

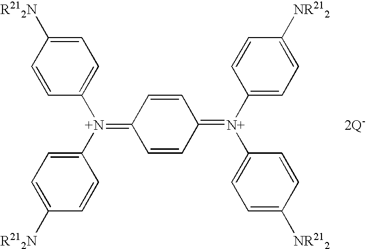

In the above formula, R²¹ represents an alkyl group which may have a substituent, and Q⁻ represents an anion.

In formula (II), R²¹ is preferably a 1-8C alkyl group which may have a substituent, far preferably an unsubstituted 1-6C alkyl group. Examples of a substituent the alkyl group may have include halogen atoms (such as F and Cl), alkoxy groups (such as methoxy and ethoxy), alkylthio groups (such as methylthio and ethylthio), acyl groups (such as acetyl and propionyl), acyloxy groups (such as acetoxy and propionyloxy), a hydroxyl group, alkoxycarbonyl groups (such as methoxycarbonyl and ethoxycarbonyl), alkenyl groups (such as vinyl) and aryl groups (such as phenyl and naphthyl) Of these substituents, halogen atoms, alkoxy groups, alkylthio groups and alkoxycarbonyl groups are preferred over the others. Suitable examples of an anion Q⁻ include ClO₄⁻, AsF₆⁻, BF₄⁻ and SbF₆⁻.

Examples of a compound represented by formula (II) are shown in Table 3.

TABLE 3

| Compound No. | R²¹ | Q⁻ |
|---|---|---|
| II-1 | CH₃ | ClO₄⁻ |
| II-2 | C₂H₅ | ClO₄⁻ |
| II-3 | n-C₃H₇ | ClO₄⁻ |
| II-4 | n-C₄H₉ | ClO₄⁻ |
| II-5 | n-C₅H₁₁ | ClO₄⁻ |
| II-6 | n-C₄H₉ | SbF₆⁻ |
| II-7 | n-C₄H₉ | BF₄⁻ |
| II-8 | n-C₄H₉ | AsF₆⁻ |

The amount of a discoloration inhibitor used, such as the foregoing singlet-oxygen quencher, is generally from 0.1 to 50% by mass, preferably from 0.5 to 45% by mass, far preferably from 3 to 40% by mass, particularly preferably from 5 to 25% by mass, of the amount of dye used.

<Mode of Optical Information Recording Medium>

The present optical information recording medium is preferably in a mode [1] that a 0.7 to 2 mm-thick substrate is provided with a dye-containing write-once recording layer and a 0.01 to 0.5 mm-thick cover layer in order of mention, or in a mode [2] that a 0.1 to 1.0 mm-thick substrate is provided with a dye-containing write-once recording layer and a 0.1 to 1.0 mm-thick protective substrate in order of mention. It is appropriate that the pregroove formed on the substrate in the mode [1] have a track pitch of 50 to 500 nm, a groove width of 25 to 250 nm and a groove depth of 5 to 150 nm, the pregroove formed on the substrate in the mode [2] have a track pitch of 200 to 600 nm, a groove width of 50 to 300 nm and a groove depth of 30 to 200 nm, and the wobbling amplitude of these pregrooves each be from 10 to 50 nm.

The optical information recording medium in the mode [1] has at least a substrate, a write-once recording layer and a cover layer. To begin with, these essential members are described step by step.

[Substrate in Mode [1]]

On the substrate in one preferred mode [1], it is required to form a pregroove (a guiding groove) having specific geometries that its track pitch, groove width (half width), groove depth and wobbling amplitude are within the ranges defined above, respectively. The pregroove having such geometries is formed in order to achieve higher recording density than those in CD-R and DVD-R, and it permits the present optical information recording medium to be suitably used as a medium responsive to violet laser.

More specifically, the track pitch of the pregroove is required to be in the range of 50 to 500 nm, and the upper limit thereof is preferably 420 nm or below, far preferably 370 nm or below, farther preferably 330 nm or below. And the lower limit thereof is preferably 100 nm or above, far preferably 200 nm or above, farther preferably 260 nm or above. When the track pitch is below 50 nm, exact pregroove formation becomes difficult and a crosstalk trouble occurs in some cases. When the track pitch is beyond 500 nm, on the other hand, a problem of lowering the recording density is caused in some cases.

The groove width (half width) of the pregroove is required to be in the range of 25 to 250 nm, and the upper limit thereof is preferably 200 nm or below, far preferably 170 nm or below, farther preferably 150 nm or below. And the lower limit thereof is preferably 50 nm or above, far preferably 80 nm or above, father preferably 100 nm or above.

When the groove width of the pregroove is below 25 nm, insufficient groove transfer at the time of molding and increase in error rate at the time of recording occur in some cases. When the groove width of the pregroove is beyond 250 nm, on the other hand, pits formed at the time of recording are broadened to result in crosstalk and insufficient modulation degree in some cases.

The groove depth of the pregroove is required to be in the range of 5 to 150 nm, and the upper limit thereof is preferably 100 nm or below, far preferably 70 nm or below, farther preferably 50 nm or below. And the lower limit thereof is preferably 10 nm or above, far preferably 20 nm or above, farther preferably 28 nm or above. When the groove depth of the pregroove is below 5 nm, a sufficient degree of recording modulation cannot be achieved in some cases; while, when the groove depth of the pregroove is beyond 150 nm, a big drop in reflectivity occurs in some cases.

In addition, the highest groove tilt angle of the pregroove is limited preferably to 80° or below, far preferably to 70° or below, farther preferably to 60° or below, particularly preferably to 50° or below. And the lowest groove tilt angle of the pregroove is limited preferably to 20° or above, far preferably to 30° or above, farther preferably to 40° or above.

When the groove tilt angle of the pregroove is below 20°, the tracking error signals obtained are sometimes insufficient in amplitude; while, when the groove tilt angle is beyond 80°, the pregroove is difficult to mold.

The substrate for use in the invention can be arbitrarily chosen from various materials hitherto used as substrate materials for traditional optical information recording media.

Examples of such a substrate material include glass; acrylic resins, such as polycarbonate and polymethyl methacrylate; vinyl chloride resins, such as polyvinyl chloride and vinyl chloride copolymers; epoxy resin; amorphous polyolefin; polyester; and metals, such as aluminum. These materials may be used in combination of two or more thereof, if desired.

Of those materials, thermoplastic resins, such as amorphous polyolefin and polycarbonate, especially polycarbonate, are preferred over the others from the view points of moisture resistance, dimensional stability and inexpensiveness.

When those resins are used, the substrates can be made using injection molding.

The thickness of the substrate is required to be in the range of 0.7 to 2 mm. And the thickness range is preferably from 0.9 to 1.6 mm, far preferably from 1.0 to 1.3 mm.

For the flatness-improving and adhesiveness-enhancing purposes, it is preferable to form an undercoat layer on the side of the substrate where a light reflection layer as described hereinafter is to be provided.

Examples of a material for the undercoat layer include polymeric materials, such as polymethyl methacrylate, acrylic acid-methacrylic acid copolymer, styrene-maleic anhydride copolymer, polyvinyl alcohol, N-methylolacrylamide, styrene-vinyltoluene copolymer, chlorosulfonated polyethylene, nitrocellulose, polyvinyl chloride, chlorinated polyolefin, polyester, polyimide, vinyl acetate-vinyl chloride copolymer, ethylene-vinyl acetate copolymer, polyethylene, polypropylene and polycarbonate; and surface modifiers, such as silane coupling agents.

The undercoat layer can be formed in the following manner: A coating solution is prepared by dissolving or dispersing a material as recited above into an appropriate solvent, and applied to a substrate surface in accordance with a coating method, such as spin coating, dip coating or extrusion coating. The thickness of the undercoat layer is generally from 0.005 to 20 μm, preferably from 0.01 to 10 μm.

[Write-Once Recording Layer in Mode [1]]

The write-once recording layer in one preferred mode [1] is formed in the following manner: After a coating solution is prepared by dissolving a dye, together with a binder, into an appropriate solvent, a coat thereof is applied to a substrate or a light reflection layer described hereinafter and then dried. Herein, the write-once recording layer may have a single-layer or multilayer structure. In the case of a multilayer structure, the process of applying a coating solution is repeated a plurality of times.

The dye concentration in a coating solution is generally from 0.01 to 15% by mass, preferably from 0.1 to 10% by mass, far preferably from 0.5 to 5% by mass, particularly preferably from 0.5 to 3% by mass.

Examples of a solvent usable for preparing the coating solution include esters, such as butyl acetate, ethyl lactate and ethyl cellosolve; ketones, such as methyl ethyl ketone, cyclohexanone and methyl isobutyl ketone; chlorinated hydrocarbons, such as dichloromethane, 1,2-dichloroethane and chloroform; amides, such as dimethylformamide; hydrocarbons, such as methylcyclohexane; ethers, such as tetrahydrofuran, ethyl ether and dioxane; alcohol, such as ethanol, n-propanol, isopropanol, n-butanol and diacetone alcohol; fluorine-containing solvents, such as 2, 2, 3, 3-tetrafluoropropanol; and glycol ethers, such as ethylene glycol monomethyl ether, ethylene glycol monoethyl ether and propylene glycol monomethyl ether.

The solvents as recited above can be used alone or as a mixture of two or more thereof in consideration of the solubility of a dye used. To the coating solution, various additives including an antioxidant, a UV absorber, a plasticizer and a lubricant may further be added according to the intended purposes.

Examples of a coating method applicable therein include a spray coating method, a spin coating method, a dip coating method, a roll coating method, a blade coating method, a doctor roll method and a screen printing method.

At the time of coating, the temperature of the coating solution is preferably from 23° to 50° C., far preferably from 24° to 40° C.

The thickness of the thus formed write-once recording layer, measured on the groove (the convex part of the substrate), is preferably 300 nm or below, far preferably 250 nm or below, farther preferably 200 nm or below, particularly preferably 180 nm or below. The lower limit of the thickness is preferably 30 nm or above, far preferably 50 nm or above, farther preferably 70 nm or above, particularly preferably 90 nm or above.

In addition, the thickness of the write-once recording layer on the land (the concave part of the substrate) is preferably 400 nm or below, far preferably 300 nm or below, farther preferably 250 nm or below. The lower limit of the thickness is preferably 70 nm or above, far preferably 90 nm or above, farther preferably 110 nm or above.

Moreover, the ratio of the write-once recording layer thickness on the groove to the write-once recording layer thickness on the land is preferably 0.4 or above, far preferably 0.5 or above, farther preferably 0.6 or above, particularly preferably 0.7 or above. The upper limit of the ratio is preferably smaller than 1, far preferably 0.9 or below, farther preferably 0.85 or below, particularly preferably 0.8 or below.

When the coating solution contains a binder, natural organic polymeric materials including gelatin, cellulose derivatives, dextran, rosin and rubber, and synthetic organic polymeric materials including hydrocarbon resins, such as polyethylene, polypropylene, polystyrene and polyisobutylene, vinyl resins, such as polyvinyl chloride, polyvinylidene chloride and vinyl chloride-vinyl acetate copolymer, acrylic resins, such as polymethyl acrylate and polymethyl methacrylate, and initial condensates of thermosetting resins, such as polyvinyl alcohol, chlorinated polyethylene, epoxy resin, butyral resin, rubber derivatives and phenol-formaldehyde resin, can be recited as examples of the binder contained therein. In the case of using a binder in combination with a dye, the ratio of the amount of the binder used to the amount of the dye used is generally from 0.01 to 50 (by mass), preferably from 0.1 to 5 (by mass).

In the write-once recording layer, various discoloration inhibitors can be incorporated for the purpose of imparting enhanced light resistance to the write-once recording layer. As the discoloration inhibitors, singlet-oxygen quenchers are generally used. The singlet-oxygen quenchers as described in publications such as laid-open patent specifications can be utilized.

Examples of a singlet-oxygen quencher usable therein include those disclosed in JP-A-58-175693, JP-A-59-81194, JP-A-60-18387, JP-A-60-19586, JP-A-60-19587, JP-A-60-35054, JP-A-60-36190, JP-A-60-36191, JP-a-60-44554, JP-A-60-44555, JP-A-60-44389, JP-A-60-44390, JP-A-60-54892, JP-A-60-47069, JP-A-63-209995, JP-A-4-25492, JP-B-1-38680, JP-B-6-26028, German Patent No. 350399, and Nippon Kagakukai-Shi, page 1141, the Oct. issue (1992).

The amount of a discoloration inhibitor used, e.g., the singlet-oxygen quencher as recited above, is generally from 0.1 to 50% by mass, preferably from 0.5 to 45% by mass, far preferably from 3 to 40% by mass, particularly preferably from 5 to 25% by mass, of the amount of dye used.

[Cover Layer in Mode [1]]

The cover layer in one preferred mode [1] is laminated on the foregoing write-once recording layer or a barrier layer mentioned hereinafter via an adhesive or a pressure-sensitive adhesive.

The cover layer for use in the invention has no particular restriction so far as it is a film of transparent material. Examples of a transparent material suitable for such a use include acrylic resins, such as polycarbonate and polymethyl methacrylate; vinyl chloride resins, such as polyvinyl chloride and vinyl chloride copolymers; epoxy resins; amorphous polyolefins; and cellulose triacetate. Of these materials, polycarbonate and cellulose triacetate are preferred over the others.

Incidentally, the term “transparent” as used herein means that, when light for recording or playback use is incident on a material, the material has a transmittance of at least 80%.

In addition, the cover layer may contain various additives as far as they are not detrimental to the achievement of effects of the invention. For instance, UV absorbers for interception of light with wavelengths of 400 nm or shorter and dyes for interception of light with wavelengths of 500 nm or longer may be contained therein.

As to the surface property of the cover layer, it is preferable that two-dimensional and three-dimensional roughness parameters of the cover layer's surface roughness are each 5 nm or below.

From the viewpoint of the power of collecting light for recording and playback use, it is also preferable that the birefringence of the cover layer is 10 nm or below.

The thickness of the cover layer is determined as appropriate to the wavelength and NA of laser light applied for recording and playback. Specifically, the thickness of the cover layer for use in the invention is from 0.01 to 0.5 mm, preferably from 0.05 to 0.12 mm.

Further, it is preferable that the thickness of the cover layer and that of the layer formed from an adhesive or a pressure-sensitive adhesive total from 0.09 to 0.11 mm, especially from 0.095 to 0.105 mm.

Moreover, a protective layer (a hard coat layer) may be provided on the incidence side of the cover layer with the intention of preventing the surface on which the light is incident from bruising during manufacturing the optical information recording medium.

As adhesives with which the cover layer can be bonded, UV-curable resins, EB-curable resins and thermosetting resins are preferably used. Of these resins, UV-curable resins in particular are used to advantage.

When the adhesive used is a UV-curable resin, the UV-curable resin may be fed from a dispenser to the barrier layer surface as it is or in a state of the solution prepared by dissolving it in an appropriate solvent, such as methyl ethyl ketone or ethyl acetate. For the purpose of preventing warpage of the optical information recording medium manufactured, it is appropriate that the UV-curable resin constituting the adhesive layer be small in curing shrinkage. As an example of such a UV-curable resin, SD-640 manufactured by Dainippon Ink and Chemicals, Incorporated can be cited.

It is preferable that such an adhesive in a specified amount is applied to the surface of, e.g., a barrier layer to be bonded to a cover layer, the cover layer is set thereon, and the adhesive is uniformly spread out between the surface to be bonded and the cover layer by use of a spin coating technique and thereafter cured.

The thickness of the adhesive layer formed in the foregoing manner is preferably from 0.1 to 100 μm, far preferably from 0.5 to 50 μm, farther preferably 10 to 30 μm.

On the other hand, pressure-sensitive adhesives usable for bonding the cover layer include those of acrylic type, rubber type and silicone type. Of these types, pressure-sensitive adhesives of acrylic type are preferred over the others in terms of transparency and durability. Substances suitable as the pressure-sensitive adhesives of acrylic type are products obtained by copolymerizing the main monomer, such as 2-ethylhexyl acrylate or n-butyl acrylate, short-chain alkyl acrylates or methacrylates for enhancement of cohesion, such as methyl acrylate, ethyl acrylate and methyl methacrylate, and monomers for providing cross-linking agents with cross-linking sites, such as acrylic acid, methacrylic acid, acrylamide derivatives, maleic acid, hydroxylethyl acrylate and glycidyl acrylate. By appropriately controlling the mixing ratio of the main monomer to short-chain monomers and monomers for providing cross-linking sites and by properly selecting the species of those monomers to be used, the glass transition temperature (Tg) of the product obtained and the density of cross-links formed therein can be changed.

Cross-linking agents usable in combination with the foregoing pressure-sensitive adhesives are, e.g., cross-linking agents of isocyanate type. Examples of such isocyanate-type cross-linking agents include isocyanates, such as tolylene diisocyanate, 4,4′-diphenylmethane diisocyanate, hexamethylene diisocyanate, xylylene diisocyanate, naphthylene-1,5-diisocyanate, o-toluidine isocyanate, isophorone diisocyanate and triphenylmethane triisocyanate; products of these isocyanates and polyhydric alcohol; and polyisocyanates produced by condensation of those isocyanates. Examples of commodity products of those isocyanates include Coronate L, Coronate HL, Coronate 2030, Coronate 2031, Millionate MR and Millionate HTL, which are products of Nippon Polyurethane Industry Co., Ltd.; Takenate D-102, Takenate D-110N, Takenate D-200 and Takenate D-202, which are products of Takeda Pharmaceutical Company Limited; and Desmodule L, Desmodule IL, Desmodule N and Desmodule HL, which are products of Sumitomo Bayer Urethane Co., Ltd.

The layer of such a pressure-sensitive adhesive may be formed by uniformly applying the adhesive in a specified amount to the surface of a barrier layer to be bonded to a cover layer, setting the cover layer on the adhesive applied, and then curing the adhesive, or by forming in advance a uniform coating on one side of a cover layer by use of a specified amount of the pressure-sensitive adhesive, applying this coating to the surface to be bonded and then curing the adhesive.

Alternatively, a commercial pressure-sensitive adhesive film provided in advance with a pressure-sensitive adhesive layer may be used as the cover layer.

The thickness of a pressure-sensitive adhesive layer formed with the pressure-sensitive adhesive as mentioned above is preferably from 0.1 to 100 μm, far preferably from 0.5 to 50 μm, farther preferably from 10 to 30 μm.

[Other Layers in Mode [1]]

In addition to the required layers, the optical information recording medium in one preferred mode [1] may have any other layers as far as they are not detrimental to the achievement of effects of the invention. Examples of such other layers include a label layer with a desired picture, which is provided on the back of the substrate (the side opposite to the write-once recording layer forming side), a light reflection layer (described hereinafter) provided between the substrate and the write-once recording layer, a barrier layer (described hereinafter) provided between the write-once recording layer and the cover layer, and an interface layer provided between the light reflection layer and the write-once recording layer. Herein, the label layer is formed with a UV-curable resin, a thermosetting resin or a heat-dryable resin.

Additionally, each of these required and arbitrary layers may be a single layer, or may have a multilayered structure.

[Light Reflection Layer in Mode [1]]

In one preferred mode [1], it is preferable that the optical information recording medium has a light reflection layer between the substrate and the write-once for the purpose of enhancing laser light reflectivity and imparting the function of improving recording-and-playback characteristics.

The light reflection layer can be formed on the substrate by vacuum deposition, sputter deposition or ion-plating of a photoreflective material having a high laser light reflectivity.

The thickness of the light reflection layer is generally from 10 to 300 nm, preferably from 50 to 200 nm.

Additionally, the laser light reflectivity is preferably 70% or above.

Examples of a photoreflective material having a high reflectivity include metals and semimetals, such as Mg, Se, Y, Ti, Zr, Hf, V, Nb, Ta, Cr, Mo, W, Mn, Re, Fe, Co, NI, Ru, Rh, Pd, Ir, Pt, Cu, Ag, Au, Zn, Cd, Al, Ga, In, Si, Ge, Te, Pb, Po, Sn and Bi; and stainless steel. These photoreflective materials may be used alone, or as combinations of two or more thereof, or as alloys. Of these materials, Cr, Ni, Pt, Cu, Ag, Au, Al and stainless steel are preferred over the others. Among these metals, Au, Ag, Al and their alloys in particular are used to advantage. And Au, Ag and alloys thereof are the best materials.

[Process of Forming Barrier Layer (Interlayer) in Mode [1]]

In one preferred mode [I], it is preferable that the optical information recording medium has a barrier layer between the write-once recording layer and the cover-layer.

The barrier layer is provided for the purposes of enhancing the keeping quality of the write-once recording layer, improving the adhesion of the write-once recording layer to the cover layer, and making adjustments to reflectivity and thermal conductivity.

Materials usable for the barrier layer have no particular restrictions so far as they are pervious to the light used for recording and playback and can perform the foregoing functions. In general, however, materials low in perviousness to gasses and moisture, and dielectric besides, are preferable. Suitable examples of such a material include nitrides, oxides, carbides and sulfides of Zn, Si, Ti, Te, Sn, Mo and Ge. Of these materials, ZnS, MoO₂, GeO₂, TeO, SiO₂, TiO₂, ZnO, ZnS—SiO₂, SnO₂ and ZnO—Ga₂O₃ are preferable, and ZnS—SiO₂, SnO₂ and ZnO—Ga₂O₃ are far preferable.

The barrier layer can be formed using vacuum film-forming methods, such as vacuum evaporation, DC sputtering, RF sputtering and ion-plating methods. Of these methods, sputtering methods, especially RF sputtering, are preferred over the others.

The barrier layer in the invention is preferably from 1 to 200 nm, far preferably from 2 to 100 nm, farther preferably from 3 to 50 nm.

In the next place, an optical information recording medium in another preferred mode [2] is described.

The optical information recording medium in the mode [2] is an optical information recording medium having a layer structure of bonded type. Typical examples of such a layer structure are as follows:

(1) The first layer structure is a structure that a write-once recording layer, a light reflection layer and an adhesive layer are formed on a substrate in their order of mention and, on the adhesive layer, a protective substrate is provided.

(2) The second layer structure is a structure that a write-once recording layer, a light reflection layer, a protective layer and an adhesive layer are formed on a substrate in their order of mention and, on the adhesive layer, a protective substrate is provided.

(3) The third layer structure is a structure that a write-once recording layer, a light reflection layer, a first protective layer, an adhesive layer and a second protective layer are formed on a substrate in their order of mention and, on the second protective layer, a protective substrate is provided.

(4) The fourth layer structure is a structure that a write-once recording layer, a first light reflection layer, a first protective layer, an adhesive layer, a second protective layer and a second light reflection layer are formed on a substrate in their order of mention and, on the second light reflection layer, a protective substrate is provided.

(5) The fifth layer structure is a structure that a write-once recording layer, a first light reflection layer, an adhesive layer and a second light reflection layer are formed on a substrate in their order of mention and, on the second light reflection layer, a protective substrate is provided.

Additionally, the layer structures (1) to (5) are mere examples. So the arranging orders of their constituent layers may be partly interchanged, or their constituent layers may be partly omitted. Further, a write-once recording layer may be formed on the protective substrate side. This case can offer an optical information recording medium of double-sided, recording-and-playback type. Furthermore, each constituent layer may have a single-layer form, or a plural-layer form.

To take a representative example of the present optical information recording medium, the structure case in which a substrate, a write-once recording layer, a light reflection layer, an adhesive layer and a protective substrate are arranged in their order of mention is illustrated below in detail.

[Substrate in Mode [2]]

On the substrate in another preferred mode [2], it is required to form a pregroove (a guiding groove) having specific geometries that its track pitch, groove width (half width), groove depth and wobbling amplitude are within the ranges defined hereinbefore, respectively. The pregroove having such geometries is formed in order to achieve higher recording density than those in CD-R and DVD-R, and it can impart suitability for use as violet laser-responsive medium to the present optical information recording medium.

The track pitch of the pregroove is, as mentioned hereinbefore, required to be in the range of 200 to 600 nm. More specifically, the upper limit thereof is preferably 500 nm or below, far preferably 450 nm or below, farther preferably 430 nm or below. And the lower limit thereof is preferably 300 nm or above, far preferably 330 nm or above, farther preferably 370 nm or above. When the track pitch is below 200 nm, exact pregroove formation becomes difficult and a crosstalk trouble occurs in some cases. When the track pitch is beyond 600 nm, on the other hand, a problem of lowering the recording density is caused in some cases.

The groove width (half width) of the pregroove is required to be in the range of 50 to 300 nm. More specifically, the upper limit thereof is preferably 250 nm or below, far preferably 200 nm or below, farther preferably 180 nm or below. And the lower limit thereof is preferably 100 nm or above, far preferably 120 nm or above, father preferably 140 nm or above. When the groove width of the pregroove is below 50 nm, insufficient groove transfer at the time of molding and increase in error rate at the time of recording occur in some cases. When the groove width of the pregroove is beyond 300 nm, on the other hand, pits formed at the time of recording are broadened to result in crosstalk and insufficient modulation degree in some cases.

The groove depth of the pregroove is required to be in the range of 30 to 200 nm. More specifically, the upper limit thereof is preferably 170 nm or below, far preferably 140 nm or below, farther preferably 120 nm or below. And the lower limit thereof is preferably 40 nm or above, far preferably 50 nm or above, farther preferably 60 nm or above. When the groove depth of the pregroove is below 30 nm, a sufficient degree of recording modulation cannot be achieved in some cases; while, when the groove depth of the pregroove is beyond 200 nm, a big drop in reflectivity occurs in some cases.

The substrate used in the preferred mode [2] can be arbitrarily chosen from various materials hither to used as substrate materials for traditional optical information recording media. Examples of a substrate material usable in the mode [2] and those preferred over others are the same as those in the mode [1].

The thickness of the substrate is required to be from 0.1 to 1.0 mm. And the preferable range thereof is from 0.2 to 0.8 mm, especially from 0.3 to 0.7 mm.

For the flatness-improving and adhesiveness-enhancing purposes, it is preferable to form an undercoat layer on the side of the substrate where a light reflection layer as described hereinafter is to be provided. Examples of a material, coating method and thickness of the undercoat layer and those preferred over others are the same as those of the undercoat layer in the mode [1].

[Write-Once Recording Layer in Mode [2]]

Detailed description of the write-once recording layer in the preferred mode [2] are the same as those of the write-once recording layer in the preferred mode [1].

[Light Reflection Layer in Mode [2]]

In the preferred mode [2], a light reflection layer is sometimes formed on the write-once recording layer for the purpose of enhancing laser light reflectivity and imparting the function of improving recording-and-playback characteristics. Detailed description of the light reflection layer in the mode [2] is the same as that of the light reflection layer in the mode [1].

[Adhesive Layer in Mode [2]]

The adhesive layer in the preferred mode [2] is an arbitrary layer formed for enhancing adhesion of the light reflection layer to a protective substrate. As a material forming the adhesive layer, photo-curable resins are suitable. For preventing warpage of a disc obtained, photo-curable resins small in curing shrinkage are especially favorable. Examples of such a photo-curable resin include UV-curable resins (UV-curable adhesives), such as SD-640 and SD-347 manufactured by Dainippon Ink and Chemicals, Incorporated. In order to secure resilience, it is appropriate that the thickness of the adhesive layer be from 1 to 1,000 μm.

[Protective Substrate in Mode [2]]

As the protective substrate in the preferred mode [2] (dummy substrate), materials with the same properties and dimensions as the foregoing substrate has can be used. The thickness of the protective substrate is required to be from 0.1 to 1.0 mm. And the preferable range thereof is from 0.2 to 0.8 mm, especially from 0.3 to 0.7 mm.

[Protective Layer in Mode [2]]

The optical information recording medium in the preferred mode [2] may have a protective layer with the intention of physically or chemically protecting the light reflection layer and the write-once recording layer, depending on its layer structure.

Examples of a material usable for the protective layer include inorganic materials, such as ZnS, ZnS—SiO₂, SiO, SiO₂, MgF₂, SnO₂ and Si₃N₄, and organic materials, such as thermoplastic resins, thermosetting resins and UV-curable resins.

For instance, the protective layer can be formed by laminating a film obtained by extrusion of plastic on the light reflection layer via an adhesive. Alternatively, it may be provided by use of a vacuum deposition technique, a sputtering technique or a coating technique.

In the case of using a thermoplastic or thermosetting resin, the protective layer can also be formed in a manner that a coating solution is prepared by dissolving the resin in an appropriate solvent, coated on the intended layer and then dried. In the other case of using a UV-curable resin, the protective layer can also be formed in a manner that a coating solution is prepared by using the resin as it is or dissolving the resin in an appropriate solvent, coated on the intended layer, and then cured by irradiation with UV light. To these coating solutions, various additives, such as antistatic agents, antioxidants and UV absorbers, may further be added depending on the desired purposes. The thickness of the protective layer is generally from 0.1 μm to 1 mm.

[Other Layers in Mode [2]]

In addition to the layers mentioned above, the optical information recording medium in the preferred mode [2] may have any other layers as far as they are not detrimental to the achievement of effects of the invention. The detailed explanation of such additional layers is the same as that of the other layers in the mode [1].

<Optical Information Recording Method>

Optical recording of information in the invention is performed using the optical information recording medium in the preferred mode [1] or [2], e.g., under the following method: First of all, the optical information recording medium is irradiated with recording light, such as semiconductor laser, from the substrate's side or the protective layer's side while rotating the recording medium with a constant linear speed (0.5 to 10 m/sec) or a constant angular speed. By the irradiation with such light, the recording layer absorbs the light and causes local rises in its temperature. And it is thought that such temperature rises induce physical or chemical changes (e.g., formation of pits), and further cause changes in its optical characteristics, thereby recording information.

Recording light used in the invention is semiconductor laser light with an oscillation wavelength of 550 nm or below, preferably 440 nm or below, far preferably from 390 to 440 nm. Examples of a suitable light source include violet semiconductor laser having its oscillation wavelength in the range of 390 to 415 nm and violet SHG laser having its central oscillation wavelength at 425 nm, which is obtained by the infrared semiconductor laser's central oscillation wavelength of 850 nm being reduced to the half by means of an optical waveguide. In the terms of recording density, the violet semiconductor laser having its oscillation wavelength in the range of 390 to 415 nm is used to particular advantage. The playback of the information thus recorded can be performed by irradiating the optical information recording medium with the semiconductor laser from the substrate's side or the protective layer's side while rotating the recording medium with the same constant linear speed as adopted above, and by detecting the light reflected from the recording medium.

Synthesis examples of compounds for use in the invention are illustrated below. Other compounds for use in the invention can also be synthesized using methods similar to those shown below.

### SYNTHESIS EXAMPLE 1-1

### Synthesis of Compound (S-1)

The synthesis of a compound for use in the invention is carried out in accordance with the following reaction schemes (1) and (2)

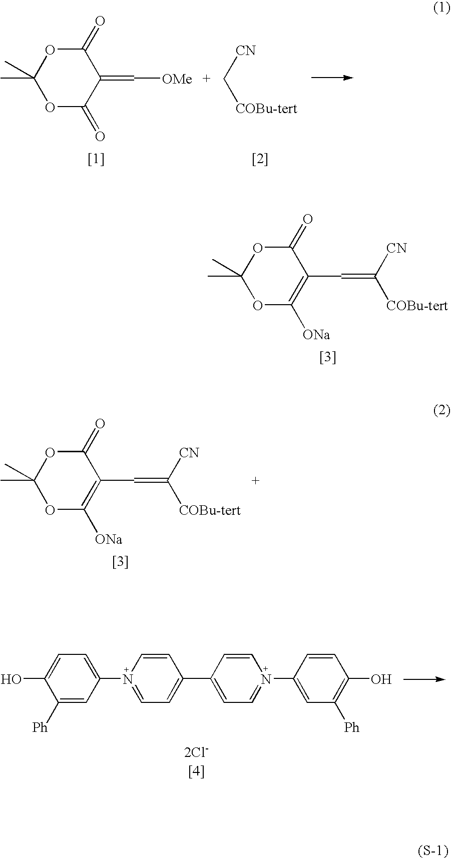

In 40 ml of methanol were dissolved 3.7 g of Compound [1] and 2.5 g of Compound [2], and thereto 1.8 g of sodium acetate was added with stirring. The resulting solution was heated under reflux for 4 hours, thereby accomplishing reaction between those compounds. After the solvent was distilled away, the reaction product was purified by column chromatography on silica gel to give 1.3 g of Compound [3].

Compound [3] in an amount of 0.65 g was dissolved in 30 ml of methanol, and then admixed with 0.57 g of Compound [4] to yield a product as crystals. The crystals were filtered off to give 0.7 g of Compound (S-1). The structure of this product was ascertained by NMR measurement.

¹HNMR (DMSO-d6): δ=1.25 (s, 9H), 1.55 (s, 6H), 7.2-8.0 (m, 8H), 8.38 (s, 1H), 9.00 (d, 2H), 9.65 (d, 2H), 10.71 (s, 1H).

### SYNTHESIS EXAMPLE 1-2

### Synthesis of Compound (S-8)

The synthesis of a compound according to the invention is carried out in accordance with the following reaction schemes (3) and (4):

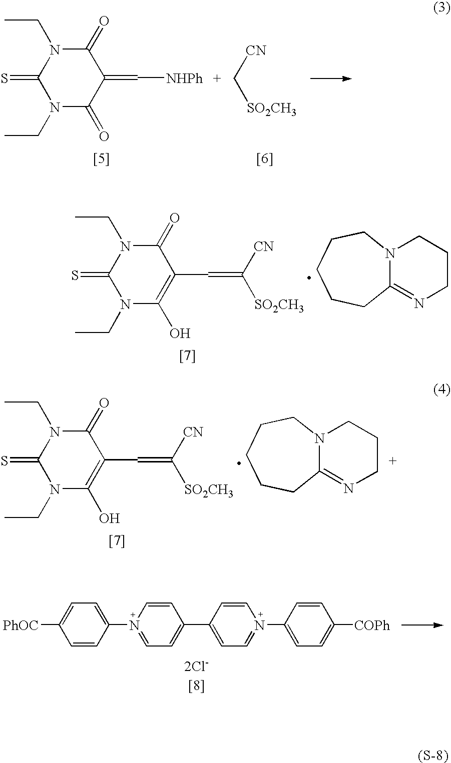

In 30 ml of ethanol were dissolved 1.7 g of Compound [5] and 0.67 g of Compound [6], and thereto 0.84 ml of 1,8-diazabicyclo(5.4.0)-7-undecene (DBU) was added with stirring. The resulting solution was heated under reflux for 2 hours, thereby accomplishing reaction between those compounds. After the solvent was distilled away, the reaction product was purified by column chromatography on silica gel to give 2.4 g of Compound [7].

Compound [7] in an amount of 0.48 g was dissolved in 10 ml of methanol, and then admixed with 0.29 g of Compound [8] to yield a product as crystals. The crystals were filtered off to give 0.5 g of Compound (S-8). The structure of this product was ascertained by NMR measurement.

¹HNMR (DMSO-d6): δ=1.16 (t, 6H), 3.07 (s, 3H), 4.38 (q, 4H), 7.6-7.9 (m, 5H), 8.02 (s, 1H), 8.14 (m, 4H), 9.12 (d, 2H), 9.80 (d, 2H).

Synthesis examples of compounds for use in the invention are illustrated below. Other compounds for use in the invention can also be synthesized using methods similar to those shown below.

### SYNTHESIS EXAMPLE 2-1

### Synthesis of Compound (S-1′)

The syntheses of a compound for use in the invention are carried out in accordance with the following reaction schemes (1) and (2):

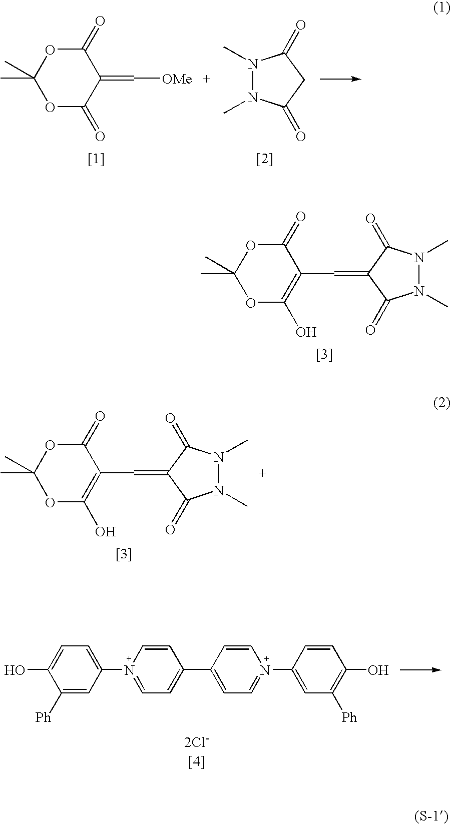

In 15 ml of methanol were dissolved 1.9 g of Compound [1] and 1.3 g of Compound [2], and thereto 1.4 ml of triethylamine was added with stirring. The resulting solution was allowed to stand for 4 hours at room temperature, thereby accomplishing reaction between those compounds. After the solvent was distilled away, the residue was admixed with 20 ml of 1N hydrochloric acid, and subjected to thorough stirring. Thus, crystals were precipitated, and they were filtered off to give 2.7 g of Compound [3]. A 0.57 g portion of Compound [3] was added to 34 ml of methanol, and further admixed with 0.57 g of Compound [4]. The resulting admixture was heated under reflux for 2 hours, and then cooled to room temperature. The crystals thus precipitated were filtered off, and thereby 0.78 g of Compound (S-1) was obtained. The structure of this compound was ascertained by NMR measurement.

¹HNMR (DMSO-d6): δ=1.58 (s, 6H), 2.96 (s, 6H), 7.2-7.9 (m, 8H), 7.94 (s, 1H), 9.05 (d, 2H), 9.70 (d, 2H), 10.83 (s, 1H).

### SYNTHESIS EXAMPLE 2-2

### Synthesis of Compound (S-4′)

The synthesis of a compound for use in the invention is carried out in accordance with the following reaction schemes (3) and (4)

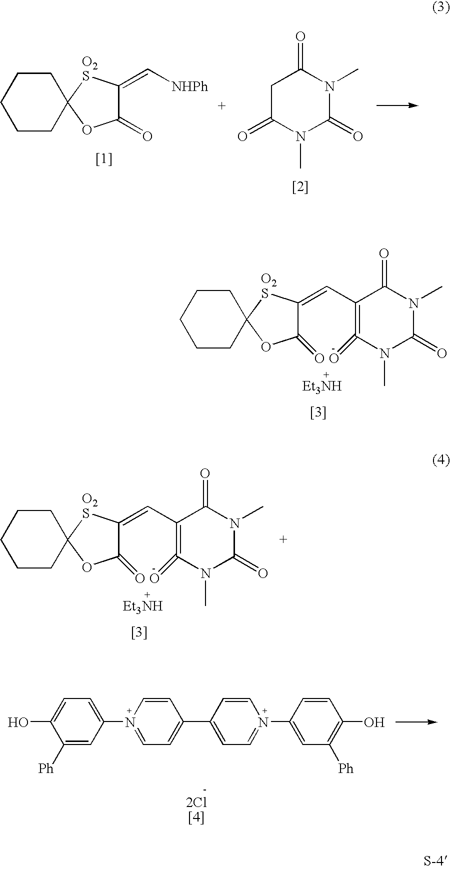

In 200 ml of acetonitrile were dissolved 17.3 g of Compound [1] and 8.78 g of Compound [2], and there to 5.31 ml of acetic anhydride was added dropwise with stirring. Thereto, 7.91 ml of triethylamine was further added dropwise, and the reaction mixture obtained was purified by chromatography to give 19.6 g of Compound [3]. A 0.67 g portion of Compound [3] was dissolved in 10 ml of methanol, and then admixed with 0.37 g of Compound [4]. Thus, a reaction product precipitated as crystals. These crystals were filtered off to give 0.66 g of Compound (S-4). The structure of this product was ascertained by NMR measurement.

¹H NMR (DMSO-d6): δ=1.3 (m, 1H), 1.5 (m, 3H), 1.75 (m, 6H), 3.1 (d, 6H), 7.2-8.0 (m, 8H), 8.05 (s, 1H), 9.00 (d, 2H), 9.65 (d, 2H), 10.71 (s, 1H).

### EXAMPLES

Now, the invention is illustrated in greater detail by reference to the following examples.

### Examples 1-1 to 1-15

### Production of Optical Information Recording Media

(Preparation of Substrate)

An extrusion-molded polycarbonate resin substrate having a thickness of 1.1 mm, an outside diameter of 120 mm, an inside diameter of 15 mm and a spiral pregroove (track pitch: 320 nm, groove width: on-groove width of 120 nm, groove depth: 35 nm, groove tilt angle: 65°, wobbling amplitude: 20 nm) was prepared. The mastering of a stamper used at the time of extrusion molding was carried out by use of laser cutting (351 nm).

(Formation of Light Reflection Layer)

On the substrate, an APC light reflection layer (Ag: 98.1 mass %, Pd: 0.9 mass %, Cu: 1.0 mass %) was formed as a 100 nm-thick vacuum deposition layer by DC sputtering performed using Unaxis Cube in an atmosphere of Ar. The thickness adjustment to the light reflection layer was made by control of the sputtering time.

(Formation of Write-Once Recording Layer)

Each of Compounds (S-1) to (S-15) shown in Table 1 was added in an amount of 2 g to 100 ml of 2,2,3,3-tetrafluoropropanol and dissolved therein to prepare a dye-containing coating solution. The dye-containing coating solution thus prepared was applied to the foregoing light reflection layer under the condition of 23° C.-50% RH by use of a spin coating technique as the number of revolutions was increased from 300 rpm to 4,000 rpm. By leaving the applied coating solution for one hour at 23° C. and 50% RH, a write-once recording layer (thickness on the groove: 120 nm, thickness on the land: 170 nm) was formed.

The write-once recording layers formed in the foregoing manner were subjected to annealing treatment in a clean oven. The annealing treatment was performed in a manner that the recording layers formed were kept at 80° C. for 1 hour in a state of being supported by a vertical stack pole as a spacing was secured between adjacent substrates with a spacer.

(Formation of Barrier Layer)

On each of the write-once recording layers, a 5 nm-thick barrier layer comprised of ZnO and Ga₂O₃ (ZnO:Ga₂O₃=7:3 (by mass)) was formed by RF sputtering of Unaxis Cube in an atmosphere of Ar.

(Lamination of Cover Layer)

A polycarbonate film (Teijin PureAce, 80 μm in thickness) having an inside diameter of 15 mm, an outside diameter of 120 mm and a pressure-sensitive adhesive coating on one side was used as a cover layer. The thickness of the pressure-sensitive adhesive coating was adjusted so that the total thickness of the pressure-sensitive adhesive coating and the cover layer reached 100 μm.

Then, the cover layer was placed on the barrier layer so that the pressure-sensitive adhesive coating was brought into face-to-face contact with the barrier layer, and pressurized with a pressing member to result in lamination of the cover layer.

### Examples 2-1 to 2-10

Discs were produced in the same manner as in Examples 1-1 to 1-15, except that Compounds (S-1′) to (S-10′) shown in Table 2 were used respectively in place of each of Compounds (S-1) to (S-15).

### Comparative Examples 1 to 4

Discs were produced in the same manner as in Examples 1 to 15, except that Comparative Compounds (A) to (D) shown described below were used respectively in place of each of Compounds (S-1) to (S-15).

Thus, the optical information recording media as Examples 1-1 to 1-15 and 2-1 to 2-10 and those as Comparative Examples 1 to 4 were produced.

<Evaluations of Optical Information Recording Media>

C/N Ratio (Carrier-to-Noise Ratio) Evaluations:

On each of the optical information recording media produced, 0.16-μm signals (2T) were recorded and played back at a clock frequency of 66 MHz and a linear velocity of 5.28 μm/s by use of an optical disc drive evaluation device (DDU-1000, made by Pulstec Industrial Co., Ltd.) equipped with 403-nm laser and a pickup with an NA of 0.85. Then, C/N ratio (after recording) measurements were made with a spectrum analyzer (Pulstec MSG2). Incidentally, these evaluations were performed using the present optical information recording method, and the recording was made on the grooves. Therein, the recording power was 5.2 mW and the playback power was 0.3 mW. Furthermore, the optical information recording media produced were kept for 24 hours in hot and humid surroundings of 60° C.-80% RH, and then subjected to the same measurements as mentioned above. Results obtained are shown in Table 3. Herein, the C/N (after recording) ratios of 25 dB or above mean that the reproduced signals have sufficient strength and are suitable for practical use.

### Examples 1-16 to 1-30

### Production of Optical Information Recording Media

(Preparation of Substrate)

An extrusion-molded polycarbonate resin substrate having a thickness of 0.6 mm, an outside diameter of 120 mm, an inside diameter of 15 mm and a spiral pregroove (track pitch: 400 nm, groove width: 170 nm, groove depth: 100 nm, groove tilt angle: 65°, wobbling amplitude: 20 nm) was prepared. The mastering of a stamper used at the time of extrusion molding was carried out by use of laser cutting (351 nm).

(Formation of Write-Once Recording Layer)

Each of Compounds (S-1) to (S-15) shown in Table 1 was added in an amount of 2 g to 100 ml of 2,2,3,3-tetrafluoropropanol and dissolved therein to prepare a dye-containing coating solution. The dye-containing coating solution thus prepared was applied to the substrate under the condition of 23° C.-50% RH by use of a spin coating technique as the number of revolutions was increased from 300 rpm to 4,000 rpm. By leaving the applied coating solution for one hour at 23° C. and 50% RH, a write-once recording layer (thickness on the groove: 170 nm, thickness on the land: 120 nm) was formed.

The write-once recording layers formed in the foregoing manner were subjected to annealing treatment in a clean oven. The annealing treatment was performed in a manner that the recording layers formed were kept at 80° C. for 1 hour in a state of being supported by a vertical stack pole as a spacing was secured between adjacent substrates with a spacer.

(Formation of Light Reflection Layer)

On each of the write-once recording layers, an APC light reflection layer (Ag: 98.1 mass %, Pd: 0.9 mass %, Cu: 1.0 mass %) was formed as a 100 nm-thick vacuum deposition layer by DC sputtering performed using Unaxis Cube in an atmosphere of Ar. The thickness adjustment to the light reflection layer was made by control of the sputtering time.

(Lamination of Protective Substrate)

A UV-curable resin (SD661, produced by Dainippon Ink and Chemicals, Incorporated) was spin-coated on the light reflection layer, laminated with a protective substrate made from polycarbonate (the same as the foregoing substrate, except that no pregroove was formed therein), and then cured by irradiation with UV rays.

In each of the optical information recording media produced, the thickness of the adhesive layer constituted of the UV-cured resin was 25 μm.

### Examples 2-11 to 2-20

Discs were produced in the same manner as in Examples 1-16 to 1-30, except that Compounds (S-1′) to (S-1′) shown in Table 2 were used respectively in place of each of Compounds (S-1) to (S-15).

### Comparative Examples 5 to 8

Discs were produced in the same manner as in Examples 1-16 to 1-30, except that Comparative Compounds (A) to (D) described below were used respectively in place of each of Compounds (S-1) to (S-15)

Thus, the optical information recording media as Examples 1-16 to 1-30 and 2-11 to 2-20 and those as Comparative Examples 5 to 8 were produced.

<Evaluations of Optical Information Recording Media>

C/N Ratio (Carrier-to-Noise Ratio) Evaluations:

On each of the optical information recording media produced, 0.2-μm signals (2T) were recorded and played back at a clock frequency of 64.8 MHz and a linear velocity of 6.6 m/s by use of an optical disc drive evaluation device (DDU-1000, made by Pulstec Industrial Co., Ltd.) equipped with 405-nm laser and a pickup with an NA of 0.65. Then, C/N ratio (after recording) measurements were made with a spectrum analyzer (Pulstec MSG2). Incidentally, these evaluations were performed using the present optical information recording method, and the recording was made on the grooves. Therein, the recording power was 12 mW and the playback power was 0.5 mW. Furthermore, the optical information recording media produced were kept for 24 hours in hot and humid surroundings of 60° C.-80% RH, and then subjected to the same measurements as mentioned above. Results obtained are shown in Table 3. Herein, the C/N ratios (after recording) of 25 dB or above mean that the reproduced signals have sufficient strength and recording characteristics are appropriate for practical use. In addition, the C/N ratios (after 24-hour storage in hot and humid surroundings of 60° C.-80% RH) of 25 dB or above mean that the keeping quality is satisfactory and suitable for practical use.

TABLE 4

| | | | C/N ratio (dB) |
|---|---|---|---|
| | | | (after 24-hour |
| | | | storage under |
| | Dye | C/N ratio | condition of |
| | compound | (dB) | 60° C.-80% RH) |
| Example 1-1 | (S-1) | 50 | 50 |
| Example 1-2 | (S-2) | 48 | 47 |
| Example 1-3 | (S-3) | 46 | 46 |
| Example 1-4 | (S-4) | 50 | 50 |
| Example 1-5 | (S-5) | 41 | 40 |
| Example 1-6 | (S-6) | 38 | 36 |
| Example 1-7 | (S-7) | 50 | 50 |
| Example 1-8 | (S-8) | 45 | 45 |
| Example 1-9 | (S-9) | 42 | 41 |
| Example 1-10 | (S-10) | 45 | 46 |
| Example 1-11 | (S-11) | 53 | 53 |
| Example 1-12 | (S-12) | 35 | 35 |
| Example 1-13 | (S-13) | 42 | 41 |
| Example 1-14 | (S-14) | 38 | 39 |
| Example 1-15 | (S-15) | 41 | 41 |
| Example 1-16 | (S-1) | 39 | 39 |
| Example 1-17 | (S-2) | 38 | 37 |
| Example 1-18 | (S-3) | 39 | 39 |
| Example 1-19 | (S-4) | 39 | 39 |
| Example 1-20 | (S-5) | 40 | 40 |
| Example 1-21 | (S-6) | 41 | 40 |
| Example 1-22 | (S-7) | 38 | 38 |
| Example 1-23 | (S-8) | 39 | 39 |
| Example 1-24 | (S-9) | 39 | 39 |
| Example 1-25 | (S-10) | 40 | 40 |
| Example 1-26 | (S-11) | 39 | 39 |
| Example 1-27 | (S-12) | 40 | 40 |
| Example 1-28 | (S-13) | 40 | 40 |
| Example 1-29 | (S-14) | 39 | 40 |
| Example 1-30 | (S-15) | 38 | 38 |
| Example 2-1 | (S-1′) | 42 | 40 |
| Example 2-2 | (S-2′) | 48 | 47 |
| Example 2-3 | (S-3′) | 44 | 43 |
| Example 2-4 | (S-4′) | 45 | 41 |
| Example 2-5 | (S-5′) | 41 | 40 |
| Example 2-6 | (S-6′) | 38 | 36 |
| Example 2-7 | (S-7′) | 44 | 40 |
| Example 2-8 | (S-8′) | 45 | 45 |
| Example 2-9 | (S-9′) | 42 | 41 |
| Example 2-10 | (S-10′) | 45 | 46 |
| Example 2-11 | (S-1′) | 53 | 53 |
| Example 2-12 | (S-2′) | 49 | 46 |
| Example 2-13 | (S-3′) | 42 | 41 |
| Example 2-14 | (S-4′) | 39 | 39 |
| Example 2-15 | (S-5′) | 41 | 41 |
| Example 2-16 | (S-6′) | 39 | 39 |
| Example 2-17 | (S-7′) | 39 | 37 |
| Example 2-18 | (S-8′) | 44 | 39 |
| Example 2-19 | (S-9′) | 39 | 39 |
| Example 2-20 | (S-10′) | 41 | 40 |
| Comparative Example 1 | (A) | 18 | 13 |
| Comparative Example 2 | (B) | 10 | 2 |
| Comparative Example 3 | (C) | 40 | 22 |
| Comparative Example 4 | (D) | 38 | impossible to |
| | | | measure because |
| | | | of crystallization |
| Comparative Example 5 | (A) | 16 | 11 |
| Comparative Example 6 | (B) | 10 | 3 |
| Comparative Example 7 | (C) | 30 | 20 |
| Comparative Example 8 | (D) | 28 | impossible to |
| | | | measure because |
| | | | of crystallization |

Comparative Compound A (Example (b) disclosed in JP-A-11-53758) 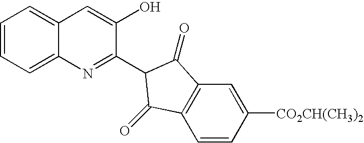
Comparative Compound B (Example (c) disclosed in JP-A-11-53758) 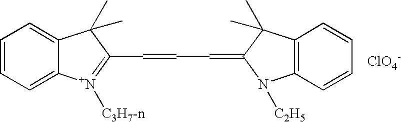
Comparative Compound C (Example (32) disclosed in JP-A-2001-71638) 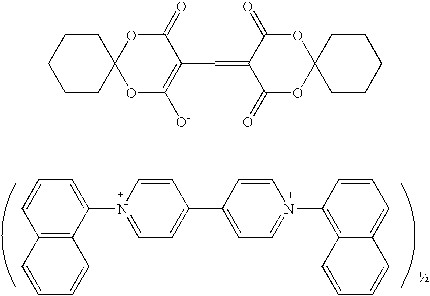
Comparative Compound D (Example (34) disclosed in JP-A-2001-71638)

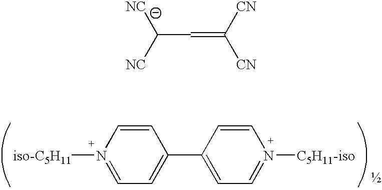

As can be seen from the results shown in Table 4, the recording media 1-1 to 1-30 and 2-1 to 2-20 provided with recording layers containing the compounds according to the invention delivered reproduced signals of high strength and satisfactory keeping quality under high temperature-high humidity conditions, as compared with the comparative examples 1 to 8.

### INDUSTRIAL APPLICABILITY

By use of dye compounds according to the invention, optical information recording media obtained can have both excellent recording characteristics and satisfactory keeping quality. These excellent effects can be achieved, notably by use of laser light with shorter wavelengths than those of the laser light used in the cases of CD-R and DVD-R, so the invention can provide optical media capable of recording information in the higher density and a method of recording and reproducing information by use of such optical media.

1. An optical information recording medium, comprising on a substrate a recording layer containing a dye compound represented by either formula (I-1) or formula (I-2) or both; 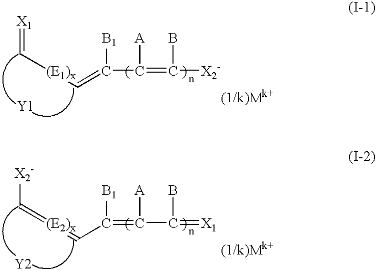
wherein moieties with the same symbols have the same meanings, respectively, and A, B and B₁ each independently represents a hydrogen atom or a univalent substituent, Y1 and Y2 each represents atoms forming a carbon ring or a hetero ring in conjunction with C-(E₁)ₓ-C or C=(E₂)ₓ=C, E₁ and E₂ each represents atoms completing a conjugated double bond chain, X₁ represents ═O, ═NR1 or ═C(R2)R3 wherein R1, R2 and R3 each independently represents a univalent substituent, X₂ represents —O, —NR1 or —C(R2)R3 wherein R1, R2 and R3 each independently represents a univalent substitutent, x represents 0 or 1, n represents 0, 1 or 2 wherein, when n is 2, two As are the same or different and two Bs are the same or different, M^{K+} represents a cation, and k represents an integer of 1 to 10.

2. An optical information recording medium as described in claim 1, further comprising:
a light reflection layer comprising metal; and/or
a protective layer.

3. An optical information recording medium as described in claim 1,
wherein the substrate is a disk-form substrate having in a surface part a pregroove with a track pitch of 0.2 to 0.5 μm and the recording layer is provided on the pregroove-formed surface of the substrate.

4. An optical information recording method, comprising recording information on an optical information recording medium as described in claim 1 by irradiation with laser light of a wavelength of 550 nm or shorter.

5. An optical information recording medium, comprising a recording layer that contains a dye compound represented by formula (II-1); 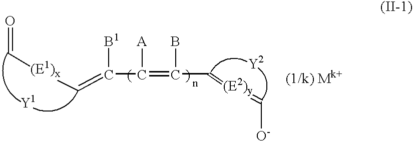
wherein A, B and B¹ each independently represents a hydrogen atom or a substituent; Y¹ and Y² each represents atoms forming a carbon ring or a hetero ring in conjunction with C-(E¹)ₓ-C or C=(E²)_{y}=C, respectively, E¹ and E² each represents atoms completing a conjugated double bond chain and x and y each represents 0 or 1, provided that the carbon rings or the hetero rings formed by Y¹ and Y² being combined with C-(E¹)ₓ—C and C=(E²)_{y}=C, respectively, are different from each other; n represents 0, 1 or 2 wherein, when n is 2, two As are the same or different and two Bs are the same or different; M^{K+} represents a cation, and k represents an integer of 1 to 10.

6. An optical information recording medium as described in claim 5, further comprising:
a light reflection layer comprising metal; and/or
a protective layer.

7. An optical information recording medium as described in claim 5, further comprising a substrate,
wherein the substrate is a disk-form substrate having in a surface part a pregroove with a track pitch of 0.2 to 0.5 μm and the recording layer containing the dye compound is provided on the pregroove-formed surface of the substrate.

8. An optical information recording method, comprising recording information on an optical information recording medium as described in claim 5 by irradiation with laser light of a wavelength of 440 nm or shorter.
